(19) United States
(12) Patent Application Publication
(10) Pub. No.: US 2026/0086329 A1
(43) Pub. Date: Mar. 26, 2026

(54) OPTICAL SYSTEM

(71) Applicant: ZHEJIANG SUNNY OPTICS CO., LTD., Yuyao City, Zhejiang (CN)

(72) Inventors: Gaoqiang GUAN, Yuyao City (CN); Shidong XU, Yuyao City (CN); Liefeng ZHAO, Yuyao City (CN); Fang ZHANG, Yuyao City (CN); Saifeng LYU, Yuyao City (CN); Peng GAO, Yuyao City (CN)

(73) Assignee: ZHEJIANG SUNNY OPTICS CO., LTD., Yuyao City, Zhejiang (CN)

(21) Appl. No.: 19/067,222

(22) Filed: Feb. 28, 2025

(30) Foreign Application Priority Data
Sep. 20, 2024 (CN) 202411318805.0

(51) Int. Cl. G02B 13/00; G02B 9/62

(52) U.S. Cl. CPC G02B 13/0045; G02B 9/62

(57) ABSTRACT

Disclosed is an optical system, including a lens barrel with an accommodating space, and a lens group and at least one spacer element accommodated in the lens barrel, wherein the lens group comprises a first lens with positive refractive power, a second lens with positive refractive power, a third lens with negative refractive power, a fourth lens with negative refractive power, a fifth lens with positive refractive power, and a sixth lens with negative refractive power, which are arranged in sequence from an object side to an image side along an optical axis; wherein the number of lenses with refractive power in the lens group is six; a center thickness CT2 of the second lens on the optical axis, a center thickness CT3 of the third lens on the optical axis, and a maximum thickness CP2 of the second spacer element satisfy: 1.36≤(CT2+CP2)/CT3≤1.71; an effective focal length f2 of the second lens, an interval EP12 between the first spacer element and the second spacer element, and an interval EP23 between the second spacer element and the third spacer element satisfy: 2.88≤f2/(EP12+EP23)≤4.15.

### CROSS-REFERENCE TO RELATED APPLICATIONS

The present application claims the priority of Chinese patent application No. 202411318805.0, filed on Sep. 20, 2024, which is hereby incorporated by reference in its entirety.

### TECHNICAL FIELD

The present application relates to the field of optical components, and in particular to an imaging system.

### BACKGROUND

With the continuous development of technology, higher requirements are placed on the optical systems of portable electronic devices. On the one hand, the optical system is required to be smaller in size; on the other hand, in order to meet consumer demand for high imaging quality, the optical system is required to have higher stability.

For the optical system, in order to ensure miniaturization, the head of the optical system is also more sensitive. When lenses are deformed by radial force, the flatness of the supporting surface of the lens mechanism is easily changed, resulting in poor assembly stability of the front-end lens.

Therefore, how to optimize the structure of the optical system to achieve system miniaturization while ensuring assembly stability and reducing the sensitivity of lens gap has become a problem that needs to be solved urgently.

### DISCLOSURE

According to an aspect of the present application, an optical system is provided, comprising a lens barrel with an accommodating space, and a lens group and at least one spacer element accommodated in the lens barrel, wherein the lens group comprises a first lens with positive refractive power, a second lens with positive refractive power, a third lens with negative refractive power, a fourth lens with negative refractive power, a fifth lens with positive refractive power, and a sixth lens with negative refractive power, which are arranged in sequence from an object side to an image side along an optical axis; and the at least one spacer element comprises a first spacer element located between the first lens and the second lens and in direct contact with an image-side surface of the first lens, a second spacer element located between the second lens and the third lens and in direct contact with an image-side surface of the second lens, and a third spacer element between the third lens and the fourth lens and in direct contact with an image-side surface of the third lens, wherein the number of lenses with refractive power in the lens group is six; a center thickness CT2 of the second lens on the optical axis, a center thickness CT3 of the third lens on the optical axis, and a maximum thickness CP2 of the second spacer element satisfy: 1.36≤(CT2+CP2)/CT3≤1.71; an effective focal length f2 of the second lens, an interval EP12 between the first spacer element and the second spacer element, and an interval EP23 between the second spacer element and the third spacer element satisfy: 2.88≤f2/(EP12+EP23)≤4.15.

In one or more embodiments, an inner diameter d0m of a rear end surface of the lens barrel closest to the imaging surface and a radius of curvature R12 of an image-side surface of the sixth lens satisfy: 0.65≤d0m/R12≤4.91.

In one or more embodiments, an interval EP01 between a front end surface of the lens barrel and the first spacer element, a center thickness CT1 of the first lens on the optical axis, and an air interval T12 between the first lens and the second lens on the optical axis satisfy: 11.59≤(EP01+CT1)/T12≤34.52.

In one or more embodiments, an air interval T34 between the third lens and the fourth lens on the optical axis, an effective focal length f3 of the third lens, and a maximum thickness CP3 of the third spacer element satisfy: −17.42≤f3/(T34+CP3)≤−2.38.

In one or more embodiments, the at least one spacer element further comprises a fourth spacer element located between the fourth lens and the fifth lens and in direct contact with an image-side surface of the fourth lens, and a center thickness CT4 of the fourth lens on the optical axis, an air interval T45 between the fourth lens and the fifth lens on the optical axis, and an interval EP34 between the third spacer element and the fourth spacer element satisfy: 0.85≤(CT4+T45)/EP34≤1.86.

In one or more embodiments, the at least one spacer element further comprises a fourth spacer element located between the fourth lens and the fifth lens and in direct contact with an image-side surface of the fourth lens, and a fifth spacer element located between the fifth lens and the sixth lens and in direct contact with an image-side surface of the fifth lens. A maximum thickness CP4 of the fourth spacer element, an interval EP45 between the fourth spacer element and the fifth spacer element, and a center thickness CT5 of the fifth lens on the optical axis satisfy: 0.99≤(CP4+EP45)/CT5≤1.53.

In one or more embodiments, a radius of curvature R1 of an object-side surface of the first lens and an outer diameter D1s of an object-side surface of the first spacer element satisfy: 0.34≤R1/D1s≤0.77.

In one or more embodiments, a radius of curvature R3 of an object-side surface of the second lens and an inner diameter dim of an image-side surface of the first spacer element satisfy: 0.75≤R3/d1m≤3.00.

In one or more embodiments, a radius of curvature R4 of the image-side surface of the second lens, a radius of curvature R5 of an object-side surface of the third lens, and an inner diameter d2m of an image-side surface of the second spacer element satisfy: 2.23≤(R4−R5)/d2m≤5.13.

In one or more embodiments, an Abbe number V3 of the third lens satisfies: 21.5≤V3≤34; a radius of curvature R6 of the image-side surface of the third lens and an inner diameter d3s of an object-side surface of the third spacer element satisfy: 0.83≤R6/d3s≤1.75.

In one or more embodiments, the at least one spacer element further comprises a fourth spacer element located between the fourth lens and the fifth lens and in direct contact with an image-side surface of the fourth lens, and an Abbe number V4 of the fourth lens satisfies: 23.7≤V4≤42.2; a radius of curvature R8 of the image-side surface of the fourth lens and an inner diameter d4s of an object-side surface of the fourth spacer element satisfy: 1.41|R8/d4s|≤6.52.

In one or more embodiments, the at least one spacer element further comprises a fourth spacer element located between the fourth lens and the fifth lens and in direct contact with an image-side surface of the fourth lens, and a radius of curvature R9 of an object-side surface of the fifth lens and an outer diameter D4m of an image-side surface of the fourth spacer element satisfy: 0.43≤R9/D4m≤0.84.

In one or more embodiments, the at least one spacer element further comprises a fifth spacer element located between the fifth lens and the sixth lens and in direct contact with an image-side surface of the fifth lens, an effective focal length f6 of the sixth lens, a center thickness CT6 of the sixth lens on the optical axis, an air interval T56 between the fifth lens and the sixth lens on the optical axis, and a maximum thickness CP5 of the fifth spacer element satisfy: −4.4≤f6/(CT6+T56+CP5)≤−2.66.

In one or more embodiments, the at least one spacer element further comprises a fifth spacer element located between the fifth lens and the sixth lens and in direct contact with an image-side surface of the fifth lens, and a radius of curvature R11 of an object-side surface of the sixth lens and an inner diameter d5m of an image-side surface of the fifth spacer element satisfy: 0.62≤|R11/d5m|≤1.95.

In one or more embodiments, an object-side surface of the first lens is a convex surface, and the image-side surface of the first lens is a concave surface; an object-side surface of the second lens is a convex surface; an image-side surface of the third lens is a concave surface; an object-side surface of the fifth lens is a convex surface, and an image-side surface of the fifth lens is a convex surface; an image-side surface of the sixth lens is a concave surface.

An optical system according to the present application comprises a lens group and at least one spacer element. The lens group may comprise six lenses with refractive power, and further comprises a lens barrel for accommodating the lens group and the spacer elements. The optical system can at the same time satisfy: 1.36≤(CT2+CP2)/CT3≤1.71 and 2.88≤f2/(EP12+EP23)≤4.15, which is beneficial for improving the system assembly stability while ensuring the miniaturization and assembly stability of the overall structure of the lens assembly, reducing the sensitivity of the front-end lens gap, and thereby improving the consistency of the lens assembly performance.

### BRIEF DESCRIPTION OF THE DRAWINGS

By reading the detailed description of the non-limiting embodiments made with reference to the following figures, other features, objectives, and advantages of the present application will become more obvious.

FIG. 1A shows a schematic structural view and partial parameters of an optical system according to an embodiment of the present application;

FIG. 1B shows a schematic view of a center point and edge points of lenses;

FIG. 2A shows a schematic structural view of an optical system according to Embodiment 1 of the present application;

FIG. 2B shows a schematic structural view of an optical system according to Embodiment 2 of the present application;

FIG. 3A to 3D show a longitudinal aberration curve, an astigmatism curve, a distortion curve, and a lateral color curve of the optical system according to Embodiment 1 and Embodiment 2 of the present application, respectively;

FIG. 4A shows a schematic structural view of an optical system according to Embodiment 3 of the present application;

FIG. 4B shows a schematic structural view of an optical system according to Embodiment 4 of the present application;

FIG. 5A to 5D show a longitudinal aberration curve, an astigmatism curve, a distortion curve, and a lateral color curve of the optical system according to Embodiment 3 and Embodiment 4 of the present application, respectively;

FIG. 6A shows a schematic structural view of an optical system according to Embodiment 5 of the present application;

FIG. 6B shows a schematic structural view of an optical system according to Embodiment 6 of the present application;

FIG. 7A to 7D show a longitudinal aberration curve, an astigmatism curve, a distortion curve, and a lateral color curve of the optical system according to Embodiment 5 and Embodiment 6 of the present application, respectively;

FIG. 8A shows a schematic structural view of an optical system according to Embodiment 7 of the present application;

FIG. 8B shows a schematic structural view of an optical system according to Embodiment 8 of the present application; and

FIG. 9A to 9D show a longitudinal aberration curve, an astigmatism curve, a distortion curve, and a lateral color curve of the optical system according to Embodiment 7 and Embodiment 8 of the present application, respectively.

### DETAILED DESCRIPTION OF EMBODIMENTS

In order to better understand the present application, various aspects of the present application will be described in more detail with reference to the accompanying drawings. It should be understood that these detailed descriptions are only descriptions of exemplary embodiments of the present application and do not limit the scope of the present application in any way. Throughout the specification, the same reference numerals refer to the same elements. The expression “and/or” comprises any and all combinations of one or more of the associated listed items.

It should be noted that in the present specification, the expressions first, second, third, etc. are only used to distinguish one feature from another feature, and do not represent any limitation on the features. Therefore, without departing from the teachings of the present application, the first lens discussed below may also be referred to as the second lens or the third lens.

In the accompanying drawings, the thickness, size and shape of the lenses have been slightly exaggerated for ease of explanation. Specifically, the shape of the spherical or aspherical surface shown in the accompanying drawings is shown by way of example. That is, the shape of the spherical or aspherical surface is not limited to the shape of the spherical or aspherical surface shown in the accompanying drawings. The accompanying drawings are only examples and are not strictly drawn to scale.

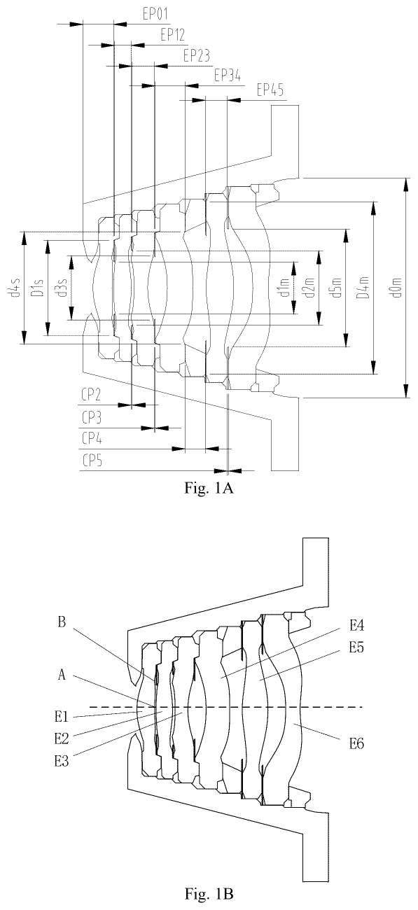

Those skilled in the art should understand that a lens is an optical component formed by a transparent medium enclosed between two refractive surfaces. The refractive surface can be a spherical surface (including a flat surface, which is a spherical surface with an infinite radius of curvature) or an aspherical surface. A line connecting the centers of curvature of the two refractive surfaces is the optical axis of a lens. In the description, a surface of the two refractive surfaces close to an object being imaged is called an object-side surface of this lens, and a surface close to an imaging surface is called an image-side surface of this lens. Each side surface has a center point and edge points. As an example, FIG. 1B shows a center point A and an edge point B of an image-side surface of a first lens E1. In fact, the center point is a special point in the middle of the lens. When light passes through this point, the propagation direction does not change. The edge point refers to a point on the lens at the maximum effective clear aperture in the direction away from the optical axis.

In the description, a paraxial region refers to a region near the optical axis. If the lens surface is a convex surface and the position of the convex surface is not defined, it means that the lens surface is convex at least in the paraxial region; if the lens surface is a concave surface and the position of the concave surface is not defined, it means that the lens surface is concave at least in the paraxial region. A surface shape in the paraxial region can be determined according to the common methods in the art, for example, the convexity or concavity can be determined by the positive or negative R value (R refers to a radius of curvature of the paraxial region). For the object-side surface, when the value of R is positive, it is determined to be convex, and when the value of R is negative, it is determined to be concave. For the image-side surface, when the value of R is positive, it is determined to be concave, and when the value of R is negative, it is determined to be convex.

The solutions described in the embodiments of this application can be simulated using software/tools such as ZEMAX and CODE V. For some embodiments, the solutions may preferably be simulated using CODE V. During the simulation process using software/tools such as those mentioned above, the surface shape of the lenses can be appropriately adjusted based on the built-in surface shape models provided by the software/tools used.

It should also be understood that the terms “comprise”, “comprising”, “having”, “include” and/or “including”, when used in this specification, indicate the presence of the stated features, elements and/or components, but do not exclude the presence or addition of one or more other features, elements, components and/or their combinations. In addition, when a statement such as “at least one of . . . ” appears after a list of listed features, it modifies the entire listed features rather than modifying individual elements in the list. In addition, when describing the embodiments of the present application, “may” is used to represent “one or more embodiments of the present application”. Furthermore, term “exemplary” refers to an example or exemplary description.

Unless otherwise specified, all terms (including technical terms and scientific terms) used in the description have the same meaning as commonly understood by those skilled in the art to which this application belongs. It should also be understood that terms (such as terms defined in common dictionaries) should be interpreted as having the same meaning as they have in the context of the relevant technology, and will not be interpreted in an idealized or overly formal sense unless explicitly so defined in the description.

It should be noted that, in the absence of conflict, the embodiments and features in the embodiments of the present application can be combined with each other. The following embodiments only express several implementations of the present application, and the descriptions thereof are relatively specific and detailed, but they cannot be understood as limiting the scope of the patent of the present application. It should be pointed out that, for those skilled in the art, several modifications and improvements can be made without departing from the concept of the present application, and these all belong to the protection scope of the present application. For example, the lens group (i.e., the first lens to the sixth lens), the lens barrel structure and the spacer elements in various embodiments of the present application can be combined arbitrarily, and are not limited to the lens group in one embodiment being combined only with the lens barrel and the spacer elements, etc. of this embodiment.

The present application will be described in detail below with reference to the accompanying drawings and in combination with the embodiments. FIG. 1A shows a structural arrangement diagram of an optical lens system according to the present application and a schematic diagram of partial parameters. Those skilled in the art should understand that some parameters frequently used in the art, such as a center thickness CT1 of the first lens on the optical axis and a maximum height L of the lens barrel along the optical axis, are not shown in FIG. 1A. FIG. 1A only exemplarily shows partial parameters of the lens barrel and spacer elements of an optical system of the present application to facilitate a better understanding of the present invention. As shown in FIG. 1A, EP01 represents an interval between a front end surface of the lens barrel close to an object side and an object-side surface of the first spacer element along the optical axis; EP12 represents an interval between an image-side surface of the first spacer element and an object-side surface of the second spacer element along the optical axis; EP23 represents an interval between an image-side surface of the second spacer element and an object-side surface of the third spacer element along the optical axis; EP34 represents an interval between an image-side surface of the third spacer element and an object-side surface of the fourth spacer element along the optical axis; EP45 represents an interval between an image-side surface of the fourth spacer element and an object-side surface of the fifth spacer element along the optical axis; CP 2 represents a maximum thickness of the second spacer element along the optical axis; CP3 represents a maximum thickness of the third spacer element along the optical axis; CP4 represents a maximum thickness of the fourth spacer element along the optical axis; CP5 represents a maximum thickness of the fifth spacer element along the optical axis; d0m represents an inner diameter of the rear end surface of the lens barrel close to the image side, which is closest to the imaging plane; Dis represents an outer diameter of the object-side surface of the first spacer element; dim represents an inner diameter of the image-side surface of the first spacer element; d2s represents an inner diameter of the object-side surface of the second spacer element; d2m represents an inner diameter of the image-side surface of the second spacer element, and so on.

The features, principles and other aspects of the present application are described in detail below.

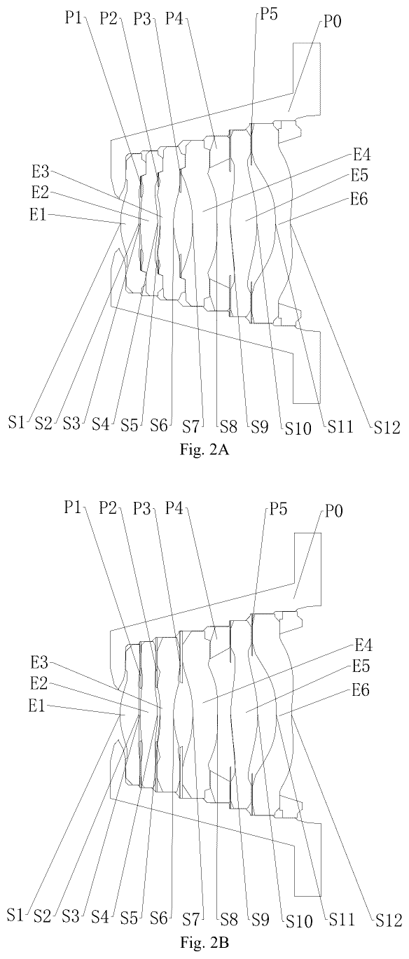

Referring to FIGS. 2A and 2B, FIGS. 4A and 4B, FIGS. 6A and 6B, and FIGS. 8A and 8B, a first aspect of the present application provides an optical system, comprising a lens barrel, a lens group and at least one spacer element, wherein the lens group and one or more spacer elements are accommodated in the lens barrel. The lens group may comprise six lenses with refractive power, which are a first lens, a second lens, a third lens, a fourth lens, a fifth lens and a sixth lens arranged in sequence from an object side to an image side along an optical axis. Any two adjacent lenses from the first lens to the sixth lens may have a spacing distance between them.

In an exemplary embodiment, the first lens may have positive refractive power. The second lens may have positive refractive power. The third lens may have negative refractive power. The fourth lens may have negative refractive power. The fifth lens may have positive refractive power. The sixth lens element may have negative refractive power.

According to an exemplary embodiment of the present application, the optical system comprises at least one spacer element, and the at least one spacer element may comprise any one or more of the following spacer elements: a first spacer element located between the first lens and the second lens and in direct contact with an image-side surface of the first lens, a second spacer element located between the second lens and the third lens and in direct contact with an image-side surface of the second lens, a third spacer element located between the third lens and the fourth lens and in direct contact with an image-side surface of the third lens, a fourth spacer element located between the fourth lens and the fifth lens and in direct contact with an image-side surface of the fourth lens, and a fifth spacer element located between the fifth lens and the sixth lens and in direct contact with an image-side surface of the fifth lens, etc. A spacer element may come into contact with an non-optical region on the image-side surface of the adjacent lens, for example, the second spacer element may abut against the non-optical region on the image-side surface of the second lens. As an example, the spacer elements may comprise shims, light-blocking sheets, spacer rings, or retaining rings, etc. By appropriately designing the number, thickness, inner diameter and outer diameter of the spacer elements, it is helpful to block stray light, improve the imaging quality of the optical system, and improve the assembly stability of the optical system.

It should be understood that a surface of each spacer element closest to an object being imaged can be called an object-side surface of this spacer element, and a surface of each spacer element closest to the imaging surface can be called an image-side surface of this spacer element. A surface of the lens barrel closest to an object being imaged can be called an object-side end surface or a front end surface of the lens barrel, and a surface of the lens barrel closest to the imaging surface can be called an image-side end surface or a rear end surface of the lens barrel.

In an exemplary embodiment, there may be at least one edged lens in the lens group. An outer peripheral surface of the edged lens may have an edged portion and a non-edged portion, and an outer diameter of the edged portion of the lens is smaller than an outer diameter of the non-edged portion of the lens. When the outer peripheral surface of the lens has a edged portion, an outer diameter of the lens generally refers to an outer diameter of the non-edged portion of the lens.

In an exemplary embodiment, the at least one of the spacer elements may have at least one edged spacer element therein. An outer peripheral surface of the edged spacer element may have a edged portion and a non-edged portion, and an outer diameter of the edged portion of the spacer element is smaller than an outer diameter of the non-edged portion of the spacer element. The outer diameter of a spacer element generally refers to the largest outer diameter of the uncut portion.

In an exemplary embodiment, the optical system according to the present application may satisfy the following conditional formulas: 1.36≤(CT2+CP2)/CT3≤1.71; 2.88≤f2/(EP12+EP23)≤4.15, wherein CT2 is a center thickness of the second lens on the optical axis, CP2 is a maximum thickness of the second spacer element, and CT3 is a center thickness of the third lens on the optical axis. Through the above parameter control, on the one hand, by appropriately controlling the ratio of the sum of the center thickness of the second lens and the thickness of the second spacer element to the center thickness of the third lens, the thickness difference of the first few lenses is reduced, which is beneficial to the miniaturization of the overall structure of the lens assembly and the assembly stability; on the other hand, by appropriately controlling the ratio of the effective focal length of the second lens to the sum of the interval between the first and second spacer elements and the interval between the second and third spacer elements, the influence of assembly deformation on lens performance is weakened. By satisfying the above two conditional formulas at the same time, it is beneficial for the optical system to improve assembly stability, reduce gap sensitivity, and improve the consistency of lens assembly performance.

In an exemplary embodiment, the optical system according to the present application may satisfy the following conditional formula: 0.65≤d0m/R12≤4.91, wherein d0m is an inner diameter of the rear end surface of the lens barrel closest to the imaging surface, and R12 is a radius of curvature of an image-side surface of the sixth lens. By satisfying this conditional formula, and by appropriately controlling the ratio of the inner diameter of the rear end surface of the lens barrel closest to the imaging surface to the radius of curvature of the image-side surface of the sixth lens, it is beneficial to ensure the overall miniaturization of the lens assembly, and at the same time, it is beneficial to improve the RI (relative illumination) of the marginal field of view of the lens assembly, limit the stray light at the rear end of the lens barrel, and thus improve the overall imaging capability of the lens assembly.

In an exemplary embodiment, the optical system according to the present application may satisfy the following conditional formula: 11.59≤(EP01+CT1)/T12≤34.52, wherein EP01 is an interval between the front end surface of the lens barrel and the first spacer element, CT1 is a center thickness of the first lens on the optical axis, and T12 is an air interval between the first lens and the second lens on the optical axis. By satisfying this conditional formula, and by appropriately controlling the ratio of the sum of the interval between the front end surface of the lens barrel and the first spacer element and the center thickness of the first lens to an air interval between the first lens and the second lens on the optical axis, the interval between the object-side surface of the first lens and the front end surface of the lens barrel on the optical axis is limited, ensuring that an object-side surface of the lens assembly does not protrude from the front end surface of the lens barrel, thereby protecting the lens assembly.

In an exemplary embodiment, the optical system according to the present application may satisfy the following conditional formula: −17.42≤f3/(T34+CP3)≤−2.38, wherein f3 is an effective focal length of the third lens, T34 is an air interval between the third lens and the fourth lens on the optical axis, and CP3 is a maximum thickness of the third spacer element. By satisfying this conditional formula, and by appropriately controlling the ratio of the effective focal length of the third lens to the sum of the air interval between the third lens and the fourth lens on the optical axis and the maximum thickness of the third spacer element, more light can be converged on the object-side surface of the fourth lens, which helps to improve the imaging quality of the lens assembly.

In an exemplary embodiment, the optical system according to the present application may satisfy the following conditional formula: 0.85≤(CT4+T45)/EP34≤1.86, wherein CT4 is a center thickness of the fourth lens on the optical axis, T45 is an air interval between the fourth lens and the fifth lens on the optical axis, and EP34 is an interval between the third spacer element and the fourth spacer element. By satisfying this conditional formula, and by appropriately controlling the ratio of the center thickness of the fourth lens on the optical axis to the sum of the air interval between the fourth lens and the fifth lens on the optical axis and the interval between the third and fourth spacer elements, the overall change of the middle thickness of the lens assembly can be controlled to be uniform, which is beneficial to reducing the thickness ratio of the fifth lens and preventing welding marks from being generated during lens forming.

In an exemplary embodiment, the optical system according to the present application may satisfy the following conditional formula: 0.99≤(CP4+EP45)/CT5≤1.53, wherein CP4 is a maximum thickness of the fourth spacer element, EP45 is an interval between the fourth spacer element and the fifth spacer element, and CT5 is a center thickness of the fifth lens on the optical axis. By satisfying this conditional formula, and by appropriately controlling the ratio of the sum of the maximum thickness of the fourth spacer element and the interval between the fourth and fifth spacer elements to the center thickness of the fifth lens on the optical axis, the purpose of controlling a thickness of the lens structure position when the fourth lens and the fifth lens are assembled can be achieved. Specifically, since the interval between the effective aperture edges of the fourth lens and the fifth lens is too large, the edge thickness of the fourth lens and the fifth lens is reduced by adopting spacer elements of a certain thickness, and controlling the thickness of the spacer elements, thereby preventing the lens thickness ratio from being too large and the forming from being difficult, and at the same time reducing the deformation risk caused by assembly and reducing the sensitivity of the lens assembly.

In an exemplary embodiment, the optical system according to the present application may satisfy the following conditional formula: 0.34≤R1/D1s≤0.77, wherein R1 is a radius of curvature of an object-side surface of the first lens, and D1s is an outer diameter of an object-side surface of the first spacer element. By satisfying this conditional formula, and by appropriately controlling the ratio of the radius of curvature of the object-side surface of the first lens to the outer diameter of the object-side surface of the first spacer element, the gradient change in the outer diameter between the first lens and the subsequent lens group can be effectively controlled to avoid a poor assembly stability caused by an excessive gradient change in the outer diameter, thereby facilitating the performance stability of the lens assembly.

In an exemplary embodiment, the optical system according to the present application may satisfy the following conditional formula: 0.75≤R3/d1m≤3.00, wherein R3 is a radius of curvature of an object-side surface of the second lens, and dim is an inner diameter of an image-side surface of the first spacer element. By satisfying this conditional formula, and by appropriately controlling the ratio of the radius of curvature of the object-side surface of the second lens to the inner diameter of the image-side surface of the first spacer element, it is beneficial to reduce the risk of stray light generated by light outside the field of view and improve the imaging capability of the lens assembly.

In an exemplary embodiment, the optical system according to the present application may satisfy the following conditional formula: 2.23≤(R4−R5)/d2m≤5.13, wherein R4 is a radius of curvature of the image-side surface of the second lens, R5 is a radius of curvature of an object-side surface of the third lens, and d2m is an inner diameter of an image-side surface of the second spacer element. By satisfying this conditional formula, and by appropriately controlling the ratio of the difference between the radius of curvature of the image-side surface of the second lens and the radius of curvature of the object-side surface of the third lens to the inner diameter of the image-side surface of the second spacer element, the luminous flux of the outgoing light from the image-side surface of the second lens to the object-side surface of the third lens is adjusted, thereby enhancing the ability of focusing the light at the front end of the lens group and ensuring the imaging quality of the lens assembly.

In an exemplary embodiment, the optical system according to the present application may satisfy the following conditional formulas: 21.5≤V3<34; 0.83≤R6/d3s≤1.75, wherein V3 is an Abbe number of the third lens, R6 is a radius of curvature of the image-side surface of the third lens, and d3s is an inner diameter of an object-side surface of the third spacer element. By specifying the Abbe number of the third lens less than 35 and at the same time satisfying the conditional formula 0.83≤R6/d3s≤1.75, and further by appropriately controlling the ratio of the radius of curvature of the image-side surface of the third lens to the inner diameter of the object-side surface of the third spacer element, it is helpful to control the stray light generated by the light of different wavelengths emitted from the image-side surface of the third lens to the rear part of the lens group, reduce the risk of stray light, and improve the imaging capability of the lens assembly.

In an exemplary embodiment, the optical system according to the present application may satisfy the following conditional formulas: 23.7≤V4≤42.2; 1.41≤|R8/d4s|≤6.52, wherein V4 is an Abbe number of the fourth lens, R8 is a radius of curvature of the image-side surface of the fourth lens, and d4s is an inner diameter of an object-side surface of the fourth spacer element. By specifying the Abbe number of the fourth lens less than or equal to 56 and at the same time satisfying the conditional formula 1.41≤|R8/d4s|≤6.52, and further by appropriately controlling the absolute value of the ratio of the radius of curvature of the image-side surface of the fourth lens to the inner diameter of the object-side surface of the fourth spacer element, the contact area between the spacer element and the fourth lens is ensured, and the spacer element is prevented from being deformed due to force during the assembly process, which is beneficial to improve the assembly stability of the lens assembly.

In an exemplary embodiment, the optical system according to the present application may satisfy the following conditional formula: 0.43≤R9/D4m≤0.84, wherein R9 is a radius of curvature of an object-side surface of the fifth lens, and D4m is an outer diameter of the image-side surface of the fourth spacer element. By satisfying this conditional formula, and by appropriately controlling the ratio of the radius of curvature of the fifth lens to the outer diameter of the image-side surface of the fourth spacer element, it is helpful to reduce the outer diameter difference between the fourth lens and the fifth lens, so that the overall change of the inner diameter step dimensions of the lens barrel is more uniform, and the miniaturization of the lens assembly is ensured.

In an exemplary embodiment, the optical system according to the present application may satisfy the following conditional formula: −4.4≤f6/(CT6+T56+CP5)≤−2.66, wherein f6 is an effective focal length of the sixth lens, CT6 is a center thickness of the sixth lens on the optical axis, T56 is an air interval between the fifth lens and the sixth lens on the optical axis, and CP5 is a maximum thickness of the fifth spacer element. By satisfying this conditional formula, and by appropriately controlling the ratio of the effective focal length of the sixth lens to the sum of the center thickness of the sixth lens on the optical axis, the air interval between the fifth lens and the sixth lens on the optical axis, and the maximum thickness of the fifth spacer element, it is helpful to ensure the assembly stability of the sixth lens. Since the distance between the effective aperture edge and the effective diameter midpoint of the sixth lens on the optical axis is relatively large, the lens assembly is prone to deformation when being assembled and subjected to force, which can adversely affect the performance of the lens assembly. Therefore, by controlling the above parameter relationship, the performance stability of the lens assembly can be effectively guaranteed.

In an exemplary embodiment, the optical system according to the present application may satisfy the following conditional formula: 0.62≤|R11/d5m|≤1.95, wherein R11 is a radius of curvature of an object-side surface of the sixth lens, and d5m is an inner diameter of an image-side surface of the fifth spacer element. By satisfying this conditional formula, and by appropriately controlling the absolute value of the ratio of the radius of curvature of the object-side surface of the sixth lens to the inner diameter of the image-side surface of the fifth spacer element, it is helpful to control the shape of the sixth lens, improve the forming of the sixth lens, and at the same time make the assembly more reasonable and improve the performance stability of the lens assembly.

Referring to FIGS. 2A and 2B, FIGS. 4A and 4B, FIGS. 6A and 6B, and FIGS. 8A and 8B, a second aspect of the present application provides an optical system, which may comprise a lens barrel, a lens group and at least one spacer element, and the lens group and one or more spacer elements are all accommodated in the lens barrel. The lens group may comprise six lenses with refractive power, which are a first lens, a second lens, a third lens, a fourth lens, a fifth lens and a sixth lens arranged in sequence from an object side to an image side along an optical axis. Any two adjacent lenses from the first lens to the sixth lens may have a spacing distance between them. The optical system further comprises at least one spacer element, which may comprise any one or more of the following spacer elements: a first spacer element located between the first lens and the second lens and in direct contact with an image-side surface of the first lens, a second spacer element located between the second lens and the third lens and in direct contact with an image-side surface of the second lens, a third spacer element located between the third lens and the fourth lens and in direct contact with an image-side surface of the third lens, a fourth spacer element located between the fourth lens and the fifth lens and in direct contact with an image-side surface of the fourth lens, and a fifth spacer element located between the fifth lens and the sixth lens and in direct contact with an image-side surface of the fifth lens, etc.

In an exemplary embodiment, the optical system according to the present application may satisfy the following conditional formula: 0.99≤(CP4+EP45)/CT5≤1.53, wherein CP4 is a maximum thickness of the fourth spacer element, EP45 is an interval between the fourth spacer element and the fifth spacer element, and CT5 is a center thickness of the fifth lens on the optical axis. By satisfying this conditional formula, and by appropriately controlling the ratio of the maximum thickness of the fourth spacer element to the sum of the interval between the fourth and fifth spacer elements and the center thickness of the fifth lens on the optical axis, the purpose of controlling the thickness of the lens structure position when the fourth lens and the fifth lens are assembled can be achieved. Specifically, since the effective aperture edge interval of the fourth lens and the fifth lens is too large, the edge thickness of the fourth lens and the fifth lens is reduced by adopting spacer elements of a certain thickness, and controlling the thickness of the spacer elements, thereby preventing the lens thickness ratio from being too large and the forming from being difficult, and at the same time reducing the deformation risk caused by assembly and reducing the sensitivity of the lens assembly.

Referring to FIGS. 2A and 2B, FIGS. 4A and 4B, FIGS. 6A and 6B, and FIGS. 8A and 8B, a third aspect of the present application provides an optical system, which may comprise a lens barrel, a lens group and at least one spacer element, and the lens group and one or more spacer elements are all accommodated in the lens barrel. The lens group may comprise six lenses with refractive power, which are a first lens, a second lens, a third lens, a fourth lens, a fifth lens and a sixth lens arranged in sequence from an object side to an image side along an optical axis. Any two adjacent lenses from the first lens to the sixth lens may have a spacing distance between them. The optical system further comprises at least one spacer element, which may comprise any one or more of the following spacer elements: a first spacer element located between the first lens and the second lens and in direct contact with an image-side surface of the first lens, a second spacer element located between the second lens and the third lens and in direct contact with an image-side surface of the second lens, a third spacer element located between the third lens and the fourth lens and in direct contact with an image-side surface of the third lens, a fourth spacer element located between the fourth lens and the fifth lens and in direct contact with an image-side surface of the fourth lens, and a fifth spacer element located between the fifth lens and the sixth lens and in direct contact with an image-side surface of the fifth lens, etc.

In an exemplary embodiment, the optical system according to the present application may satisfy the following conditional formula: −4.4≤f6/(CT6+T56+CP5)≤−2.66, wherein f6 is an effective focal length of the sixth lens, CT6 is a center thickness of the sixth lens on the optical axis, T56 is an air interval between the fifth lens and the sixth lens on the optical axis, and CP5 is a maximum thickness of the fifth spacer element. By satisfying this conditional formula, and by appropriately controlling the ratio of the effective focal length of the sixth lens to the sum of the center thickness of the sixth lens on the optical axis, the air interval between the fifth lens and the sixth lens on the optical axis, and the maximum thickness of the fifth spacer element, it helps to ensure the assembly stability of the sixth lens. Since the distance between the effective aperture edge and the effective diameter midpoint of the sixth lens on the optical axis is relatively large, the lens assembly is prone to deformation when being assembled and subjected to force, which can adversely affect the performance of the lens assembly. Therefore, by controlling the above parameter relationship, the performance stability of the lens assembly can be effectively guaranteed.

It should be understood that the present application does not specifically limit the number of spacer elements, and any number of spacer elements can be comprised between any two lenses, and the entire optical system can also comprise any number of spacer elements. The spacer elements help the optical system intercept excess refractive and reflective light paths and reduce the generation of stray light and ghost images. Adding auxiliary support between the spacer elements and the lens barrel is conducive to improving the problems of poor assembly stability and low performance yield caused by large step differences between lenses.

In some embodiments, the optical system according to the present application may further comprise a filter and/or a protective glass disposed between the sixth lens and the imaging surface, which is used to filter light with different wavelengths, correct color deviation, and protect photosensitive elements located on the imaging surface.

In some embodiments, the optical system according to the present application may further comprise an aperture stop disposed between the object side and the first lens. The aperture stop is conducive to the effective convergence of light entering the optical lens assembly and is conducive to reducing the aperture of the lens.

According to the optical system of the above-mentioned embodiment of the present application, the lens group may use a plurality of lenses, such as six lenses described above. By appropriately allocating the focal length, the surface shape, the center thickness of each lens and the on-axis distance between each lens, etc., an incident light can be effectively converged, a total optical length can be reduced and the processability can be improved, making the optical system more conducive to production and processing.

In an embodiment of the present application, at least one of the lens surfaces of the respective lenses from the first lens to the sixth lens is an aspherical lens surface. An aspherical lens has a characteristic that a curvature changes continuously from a center of the lens to a periphery of the lens. Unlike a spherical lens having a constant curvature from the center of the lens to the periphery of the lens, an aspherical lens has a better radius of curvature characteristic, and has the advantages of improving distortion aberration and improving astigmatism aberration. After adopting an aspherical lens, the aberration occurring during imaging can be eliminated as much as possible, thereby improving the imaging quality. Optionally, the object-side surface and image-side surface of each lens in the first lens to the sixth lens are aspherical lens surfaces.

The following further describes Embodiments 1 to 8 of the optical system according to the above exemplary embodiments with reference to the accompanying drawings.

### Embodiment 1

The optical system according to Embodiment 1 of the present application is described below with reference to FIG. 2A.

As shown in FIG. 2A, the optical system comprises a lens barrel P0, and a lens group and at least one spacer element accommodated in the lens barrel P0.

The lens group comprises, in sequence from an object side to an image side, a first lens E1, a second lens E2, a third lens E3, a fourth lens E4, a fifth lens E5 and a sixth lens E6.

The at least one spacer element comprises a first spacer element P1, a second spacer element P2, a third spacer element P3, a fourth spacer element P4 and a fifth spacer element P5.

The first lens E1 has positive refractive power, with a convex object-side surface S1 and a concave image-side surface S2. The second lens E2 has positive refractive power, with a convex object-side surface S3 and a convex image-side surface S4. The third lens E3 has negative refractive power, with a concave object-side surface S5 and a concave image-side surface S6. The fourth lens E4 has negative refractive power, with a concave object-side surface S7 and a concave image-side surface S8. The fifth lens E5 has positive refractive power, with a convex object-side surface S9 and a convex image-side surface S10. The sixth lens E6 has negative refractive power, with a concave object-side surface S11 and a concave image-side surface S12. The optical system further comprises a filter (not shown) disposed between the sixth lens E6 and the imaging surface S15. The filter has an object-side surface S13 and an image-side surface S14. Light from an object passes through each surface S1 to S14 in sequence and is finally imaged on the imaging surface S15.

Table 1 shows the basic parameters of the optical system of Embodiment 1, wherein the units for the radius of curvature and thickness/distance are in millimeters (mm).

TABLE 1

| | | | | material | | |
|---|---|---|---|---|---|---|
| surface | surface | radius of | | refractive | Abbe | |
| number | type | curvature | thickness/distance | index | number | cone coefficient |
| OBJ | spherical | infinity | 400.0000 | | | |
| STO | spherical | infinity | 0.0300 | | | |
| S1 | aspherical | 1.5571 | 0.4383 | 1.553 | 58.7 | 0.0000 |
| S2 | aspherical | 3.5042 | 0.0337 | | | 0.0000 |
| S3 | aspherical | 3.5735 | 0.4078 | 1.543 | 55.9 | 0.0000 |
| S4 | aspherical | −2.6882 | 0.0625 | | | 0.0000 |
| S5 | aspherical | −8.4144 | 0.3141 | 1.589 | 30.0 | 0.0000 |
| S6 | aspherical | 1.7187 | 0.4517 | | | 0.0000 |
| S7 | aspherical | −3.6281 | 0.5803 | 1.588 | 33.0 | 0.0000 |
| S8 | aspherical | 16.8501 | 0.3115 | | | 0.0000 |
| S9 | aspherical | 2.3852 | 0.6338 | 1.577 | 36.3 | 0.0000 |
| S10 | aspherical | −2.8623 | 0.4376 | | | 0.0000 |
| S11 | aspherical | −5.2765 | 0.3559 | 1.581 | 31.9 | 0.0000 |
| S12 | aspherical | 2.3982 | 0.2534 | | | 0.0000 |
| S13 | spherical | infinity | 0.2100 | 1.518 | 64.2 | |
| S14 | spherical | infinity | 0.4900 | | | |
| S15 | spherical | infinity | | | | |

In Embodiment 1, the object-side surface and the image-side surface of any lens from the first lens E1 to the sixth lens E6 are both aspherical surfaces, and the surface shape of each aspherical lens can be defined by but not limited to the following aspherical surface formula:

$$x = \frac{{ch}^{2}}{1 + \sqrt{1 - ( k + 1 ) {c}^{2} {h}^{2}}} + \sum {Aih}^{i} \qquad ( 1 )$$

wherein, x is a sagittal height from a vertex of the aspherical surface when the aspherical surface is at a height of h along the optical axis; c is a paraxial curvature of the aspherical surface, c=l/R (that is, the paraxial curvature c is the inverse of the radius of curvature R in Table 1 above); k is a cone coefficient; Ai is a correction coefficient of the i-th order of the aspherical surface. Tables 2-1 and 2-2 below give high-order coefficients A4, A6, A8, A10, A12, A14, A16, A18, A20, A22, A24, A26, A28 and A30 that can be used for each aspherical lens surface S1-S12 in Embodiment 1.

TABLE 2-1

| surface number | A4 | A6 | A8 | A10 | A12 | A14 | A16 |
|---|---|---|---|---|---|---|---|
| S1 | −1.2142E−02 | −1.6055E−03 | −1.6627E−04 | −1.3262E−05 | −1.1449E−06 | 7.8709E−07 | 4.6529E−07 |
| S2 | −4.2828E−02 | 4.8637E−04 | 2.8899E−04 | −1.4837E−04 | −2.9992E−05 | 1.5749E−05 | 1.9014E−06 |
| S3 | −1.8731E−02 | 5.4791E−03 | 5.1157E−04 | −3.1754E−04 | −3.6415E−05 | 3.0032E−05 | −2.3546E−06 |
| S4 | 1.7049E−02 | 3.7046E−03 | −8.9129E−04 | −4.0843E−04 | −1.6533E−04 | −5.3126E−06 | −1.4184E−05 |
| S5 | −4.3610E−02 | −1.0676E−03 | −1.8950E−03 | −4.0580E−04 | −1.9660E−04 | −1.9080E−05 | −2.4535E−05 |
| S6 | −4.4850E−02 | 3.4876E−03 | −9.7124E−04 | 2.1965E−04 | −1.2113E−05 | 4.3609E−05 | −7.6506E−06 |
| S7 | −5.0683E−02 | 1.1666E−02 | −1.1460E−03 | −2.8917E−05 | −2.5981E−04 | −1.3474E−05 | −1.3753E−06 |
| S8 | −2.6343E−01 | 4.1521E−02 | −4.3918E−03 | 1.7179E−03 | −7.4965E−04 | 3.1847E−05 | −8.1970E−05 |
| S9 | −5.0408E−01 | 5.1744E−02 | −1.2973E−02 | 4.3782E−03 | −1.4099E−03 | 2.9085E−04 | −1.7874E−04 |
| S10 | 4.6178E−01 | −4.1375E−03 | −1.4340E−02 | 2.8832E−03 | 2.5134E−04 | −1.9056E−04 | 2.8708E−04 |
| S11 | −5.4132E−01 | 2.1582E−01 | −6.0188E−02 | 1.2984E−02 | −3.0199E−03 | 7.5006E−04 | 3.8662E−05 |
| S12 | −2.9675E+00 | 2.6540E−01 | −1.7765E−01 | 2.6547E−02 | −2.6508E−02 | 1.9123E−03 | −5.9159E−03 |

TABLE 2-2

| surface number | A18 | A20 | A22 | A24 | A26 | A28 | A30 |
|---|---|---|---|---|---|---|---|
| S1 | −7.0176E−08 | −1.4406E−07 | 0.0000E+00 | 0.0000E+00 | 0.0000E+00 | 0.0000E+00 | 0.0000E+00 |
| S2 | −1.1213E−06 | −2.2623E−08 | 0.0000E+00 | 0.0000E+00 | 0.0000E+00 | 0.0000E+00 | 0.0000E+00 |
| S3 | −4.8719E−06 | −4.1471E−07 | 0.0000E+00 | 0.0000E+00 | 0.0000E+00 | 0.0000E+00 | 0.0000E+00 |
| S4 | −4.1864E−06 | −1.5857E−06 | 0.0000E+00 | 0.0000E+00 | 0.0000E+00 | 0.0000E+00 | 0.0000E+00 |
| S5 | −6.7234E−06 | −2.4147E−06 | 0.0000E+00 | 0.0000E+00 | 0.0000E+00 | 0.0000E+00 | 0.0000E+00 |
| S6 | 1.0601E−06 | −1.5428E−06 | 0.0000E+00 | 0.0000E+00 | 0.0000E+00 | 0.0000E+00 | 0.0000E+00 |
| S7 | 4.4223E−06 | −1.9565E−07 | 0.0000E+00 | 0.0000E+00 | 0.0000E+00 | 0.0000E+00 | 0.0000E+00 |
| S8 | 1.2976E−05 | −3.9707E−06 | 0.0000E+00 | 0.0000E+00 | 0.0000E+00 | 0.0000E+00 | 0.0000E+00 |
| S9 | 7.5324E−05 | −3.7315E−05 | 0.0000E+00 | 0.0000E+00 | 0.0000E+00 | 0.0000E+00 | 0.0000E+00 |
| S10 | 3.6296E−05 | −1.1622E−04 | −1.1534E−06 | 0.0000E+00 | 0.0000E+00 | 0.0000E+00 | 0.0000E+00 |
| S11 | −3.2774E−04 | 6.1696E−05 | 3.4716E−06 | 0.0000E+00 | 0.0000E+00 | 0.0000E+00 | 0.0000E+00 |
| S12 | −1.9829E−03 | −1.6726E−03 | −5.1292E−04 | 0.0000E+00 | 0.0000E+00 | 0.0000E+00 | 0.0000E+00 |

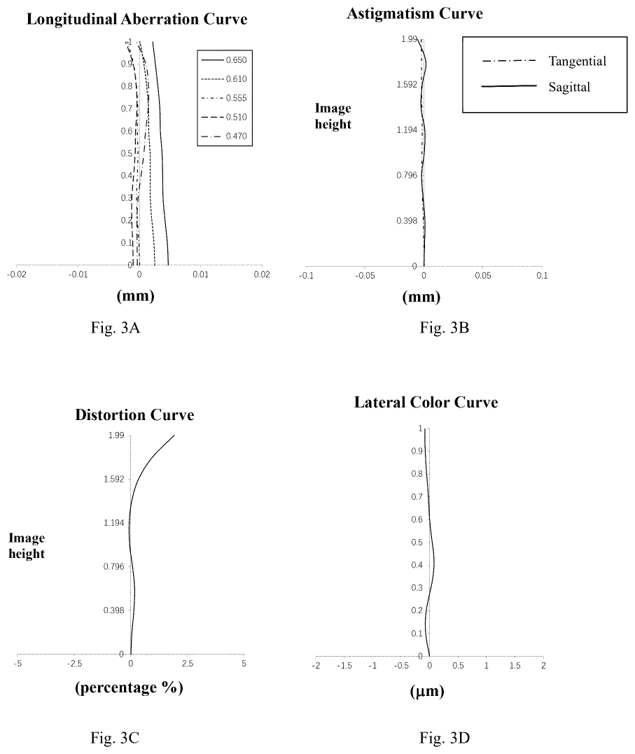

FIG. 3A shows a longitudinal aberration curve of the optical system of Embodiment 1, representing deviations of focal points of light of different wavelengths after passing through the lens assembly. FIG. 3B shows an astigmatism curve of the optical system of Embodiment 1, representing a curvature of a tangential plane and a curvature of a sagittal plane. FIG. 3C shows a distortion curve of the optical system of Embodiment 1, representing amounts of distortion corresponding to different image heights. FIG. 3D shows a lateral color curve of the optical system of Embodiment 1, representing deviation of different image heights on the imaging surface after light passes through the lens assembly. According to FIG. 3A to FIG. 3D, it can be seen that the optical system according to Embodiment 1 can achieve good imaging quality.

### Embodiment 2

The optical system according to Embodiment 2 of the present application is described below with reference to FIG. 2B. In this embodiment and the following embodiments, for the sake of brevity, some descriptions similar to Embodiment 1 will be omitted.

As shown in FIG. 2B, the optical system comprises a lens barrel P0, and a lens group and at least one spacer element accommodated in the lens barrel P0. The lens group comprises, in sequence from an object side to an image side, a first lens E1, a second lens E2, a third lens E3, a fourth lens E4, a fifth lens E5 and a sixth lens E6. The at least one spacer element comprises a first spacer element P1, a second spacer element P2, a third spacer element P3, a fourth spacer element P4 and a fifth spacer element P5.

In this embodiment, the radii of curvature, center thicknesses, and other parameters of the first to sixth lenses of the optical system, as well as the spacing distances between the lenses and the higher-order coefficients, are the same as those in Embodiment 1, as shown in Table 1, Table 2-1 and Table 2-2. In addition, the number of spacer elements comprised in the optical system of this embodiment and Embodiment 1 is also the same, and the only difference lie in the actual parameters of the lens barrel and the respective spacer elements, such as the dimensions of the lens barrel, the thickness of the spacer elements, the inner and outer diameters of the spacer elements, and the spacing distances between the spacer elements, where at least one of these parameters is different. In other words, the main structure for imaging is the same, while the auxiliary structure for imaging is different. Therefore, the imaging quality of the optical system of Embodiment 2 of the present application is shown in FIGS. 3A to 3D.

### Embodiment 3

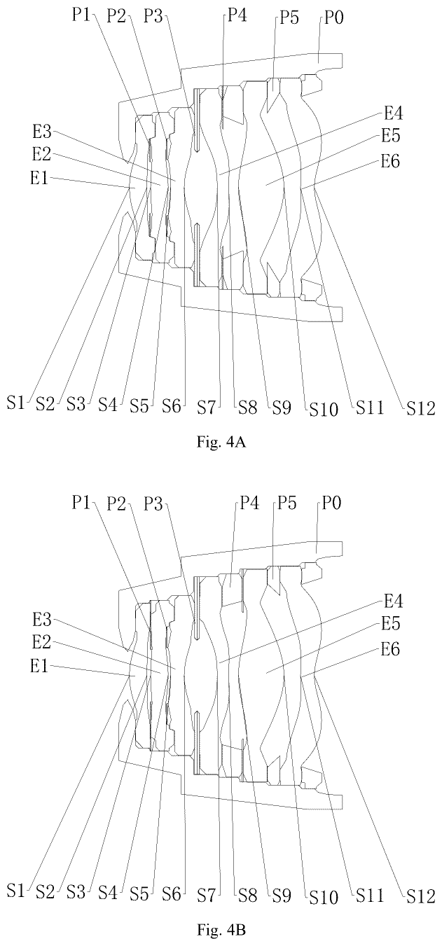

The optical system according to Embodiment 3 of the present application is described below with reference to FIG. 4A.

As shown in FIG. 4A, the optical system comprises a lens barrel P0, and a lens group and at least one spacer element accommodated in the lens barrel P0. The lens group comprises, in sequence from an object side to an image side, a first lens E1, a second lens E2, a third lens E3, a fourth lens E4, a fifth lens E5 and a sixth lens E6. The at least one spacer element comprises a first spacer element P1, a second spacer element P2, a third spacer element P3, a fourth spacer element P4 and a fifth spacer element P5.

The first lens E1 has positive refractive power, with a convex object-side surface S1 and a concave image-side surface S2. The second lens E2 has positive refractive power, with a convex object-side surface S3 and a convex image-side surface S4. The third lens E3 has negative refractive power, with a concave object-side surface S5 and a concave image-side surface S6. The fourth lens E4 has negative refractive power, with a concave object-side surface S7 and a concave image-side surface S8. The fifth lens E5 has positive refractive power, with a convex object-side surface S9 and a convex image-side surface S10. The sixth lens E6 has negative refractive power, with a convex object-side surface S11 and a concave image-side surface S12. The optical system further comprises a filter (not shown) disposed between the sixth lens E6 and the imaging surface S15.

Table 3 shows a basic parameter table of the optical system of Embodiment 3, wherein the units for the radius of curvature and the thickness/distance are in millimeters (mm).

TABLE 3

| | | | | material | | |
|---|---|---|---|---|---|---|
| surface | surface | radius of | | refractive | Abbe | |
| number | type | curvature | thickness/distance | index | number | cone coefficient |
| OBJ | spherical | infinity | 400.0000 | | | |
| STO | spherical | infinity | 0.0300 | | | |
| S1 | aspherical | 1.6048 | 0.3766 | 1.575 | 62.8 | 0.0000 |
| S2 | aspherical | 4.5756 | 0.0812 | | | 0.0000 |
| S3 | aspherical | 3.2199 | 0.3802 | 1.544 | 56.0 | 0.0000 |
| S4 | aspherical | −2.6219 | 0.0531 | | | 0.0000 |
| S5 | aspherical | −5.7283 | 0.2952 | 1.582 | 33.6 | 0.0000 |
| S6 | aspherical | 1.3450 | 0.7158 | | | 0.0000 |
| S7 | aspherical | −3.9537 | 0.2500 | 1.553 | 42.2 | 0.0000 |
| S8 | aspherical | 4.1792 | 0.2107 | | | 0.0000 |
| S9 | aspherical | 1.8891 | 0.9855 | 1.544 | 56.0 | 0.0000 |
| S10 | aspherical | −1.4673 | 0.3579 | | | −1.0000 |
| S11 | aspherical | 4.7709 | 0.3000 | 1.541 | 49.9 | 0.0000 |
| S12 | aspherical | 1.0512 | 0.1657 | | | −1.0000 |
| S13 | spherical | infinity | 0.2100 | 1.518 | 64.2 | |
| S14 | spherical | infinity | 0.4900 | | | |
| S15 | spherical | infinity | | | | |

In Embodiment 3, the object-side surface and the image-side surface of any lens from the first lens E1 to the sixth lens E6 are both aspherical surfaces, and the surface shape of each aspherical lens can be defined by the formula (1) according to Embodiment 1 above. Tables 4-1 and 4-2 below give high-order coefficients A₄, A₆, A₈, A₁₀, A₁₂, A₁₄, A₁₆, A₁₈, A₂₀, A₂₂, A₂₄, A₂₆, A₂₈ and A₃₀ that can be used for each aspherical lens surface S1-S12 in Embodiment 3.

TABLE 4-1

| surface number | A4 | A6 | A8 | A10 | A12 | A14 | A16 |
|---|---|---|---|---|---|---|---|
| S1 | −9.7496E−03 | −1.6341E−03 | −2.2806E−04 | −2.5121E−05 | −2.4495E−08 | 3.0271E−06 | 2.3626E−06 |
| S2 | −3.8848E−02 | 5.3064E−04 | −1.0221E−04 | −4.1512E−05 | −7.9935E−06 | 2.8414E−06 | 1.3136E−06 |
| S3 | −2.9498E−02 | 7.1930E−03 | 1.7959E−04 | −2.2890E−04 | −4.4741E−05 | 5.8717E−06 | 1.9490E−06 |
| S4 | 2.2672E−02 | 2.1261E−03 | −3.0507E−04 | −5.1419E−04 | −1.5912E−04 | −3.6193E−05 | −6.5463E−06 |
| S5 | −3.2118E−02 | −3.6244E−03 | −1.2247E−03 | −5.6759E−04 | −1.6685E−04 | −4.0265E−05 | −8.2181E−06 |
| S6 | −6.5857E−02 | 1.3587E−04 | −4.1230E−04 | 4.3549E−05 | 3.9427E−05 | 2.8283E−05 | 1.4180E−05 |
| S7 | −1.0594E−01 | 1.8169E−02 | −1.6503E−03 | −1.6125E−04 | −2.6333E−04 | 1.2550E−05 | 1.4913E−06 |
| S8 | −3.2260E−01 | 5.2915E−02 | −4.1851E−03 | 1.1423E−03 | −8.6463E−04 | 2.1744E−04 | −4.3888E−05 |
| S9 | −6.3883E−01 | 2.8404E−02 | −1.2642E−02 | 1.5804E−03 | −1.1263E−03 | 9.9467E−04 | −2.8423E−04 |
| S10 | 9.1121E−01 | −8.2382E−02 | 1.8440E−02 | −1.5471E−02 | 4.6683E−03 | 1.0570E−03 | −4.7413E−04 |
| S11 | −9.9038E−01 | 3.3839E−01 | −1.0547E−01 | 3.3723E−02 | −1.0787E−02 | 7.3080E−04 | 3.6742E−04 |
| S12 | −4.2086E+00 | 7.2653E−01 | −2.2065E−01 | 7.4274E−02 | −3.1940E−02 | 2.2930E−02 | −7.2215E−04 |

TABLE 4-2

| surface number | A18 | A20 | A22 | A24 | A26 | A28 | A30 |
|---|---|---|---|---|---|---|---|
| S1 | 9.2776E−07 | 2.5090E−07 | 0.0000E+00 | 0.0000E+00 | 0.0000E+00 | 0.0000E+00 | 0.0000E+00 |
| S2 | −3.6148E−07 | −1.7048E−07 | 0.0000E+00 | 0.0000E+00 | 0.0000E+00 | 0.0000E+00 | 0.0000E+00 |
| S3 | −1.3515E−06 | 7.3845E−08 | 0.0000E+00 | 0.0000E+00 | 0.0000E+00 | 0.0000E+00 | 0.0000E+00 |
| S4 | −4.0099E−06 | −9.8013E−07 | 0.0000E+00 | 0.0000E+00 | 0.0000E+00 | 0.0000E+00 | 0.0000E+00 |
| S5 | −4.3099E−06 | −8.4828E−07 | 0.0000E+00 | 0.0000E+00 | 0.0000E+00 | 0.0000E+00 | 0.0000E+00 |
| S6 | 5.4173E−06 | 2.3468E−06 | 0.0000E+00 | 0.0000E+00 | 0.0000E+00 | 0.0000E+00 | 0.0000E+00 |
| S7 | −1.1093E−05 | 1.1182E−05 | 0.0000E+00 | 0.0000E+00 | 0.0000E+00 | 0.0000E+00 | 0.0000E+00 |
| S8 | −2.0818E−06 | 1.6541E−05 | 0.0000E+00 | 0.0000E+00 | 0.0000E+00 | 0.0000E+00 | 0.0000E+00 |
| S9 | 1.2750E−04 | −3.6538E−05 | 0.0000E+00 | 0.0000E+00 | 0.0000E+00 | 0.0000E+00 | 0.0000E+00 |
| S10 | 2.6452E−04 | −2.5960E−04 | −1.2828E−05 | 0.0000E+00 | 0.0000E+00 | 0.0000E+00 | 0.0000E+00 |
| S11 | 3.2144E−04 | −2.2813E−04 | −2.7864E−06 | 0.0000E+00 | 0.0000E+00 | 0.0000E+00 | 0.0000E+00 |
| S12 | −6.9867E−04 | −4.0411E−03 | −2.7910E−04 | 0.0000E+00 | 0.0000E+00 | 0.0000E+00 | 0.0000E+00 |

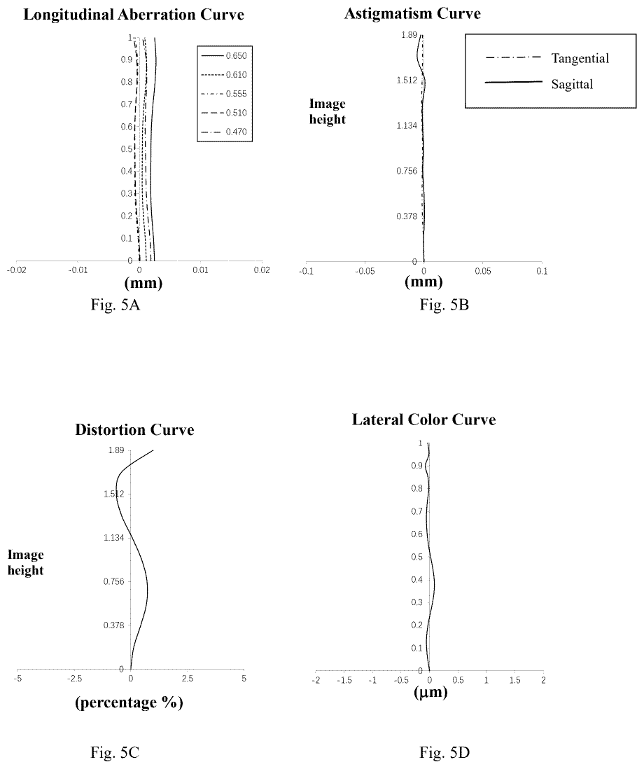

FIG. 5A shows a longitudinal aberration curve of the optical system of Embodiment 3, representing deviations of focal points of light of different wavelengths after passing through the lens assembly. FIG. 5B shows an astigmatism curve of the optical system of Embodiment 3, representing a curvature of a tangential plane and a curvature of a sagittal plane. FIG. 5C shows a distortion curve of the optical system of Embodiment 3, representing amounts of distortion corresponding to different image heights. FIG. 5D shows a lateral color curve of the optical system of Embodiment 3, representing deviation of different image heights on the imaging surface after light passes through the lens assembly. According to FIG. 5A to FIG. 5D, it can be seen that the optical system according to Embodiment 3 can achieve good imaging quality.

### Embodiment 4

The optical system according to Embodiment 4 of the present application is described below with reference to FIG. 4B.

As shown in FIG. 4B, the optical system comprises a lens barrel P0, and a lens group and at least one spacer element accommodated in the lens barrel P0. The lens group comprises, in sequence from an object side to an image side, a first lens E1, a second lens E2, a third lens E3, a fourth lens E4, a fifth lens E5 and a sixth lens E6. The at least one spacer element comprises a first spacer element P1, a second spacer element P2, a third spacer element P3, a fourth spacer element P4 and a fifth spacer element P5.

In this embodiment, the radii of curvature, center thicknesses, and other parameters of the first to sixth lenses of the optical system, as well as the spacing distances between the lenses and the higher-order coefficients, are the same as those in Embodiment 3, as shown in Table 3, Table 4-1 and Table 4-2. In addition, the number of spacer elements comprised in the optical system of this embodiment and Embodiment 3 is also the same, and the only difference lie in the actual parameters of the lens barrel and the respective spacer elements, such as the dimensions of the lens barrel, the thickness of the spacer elements, the inner and outer diameters of the spacer elements, and the spacing distances between the spacer elements, where at least one of these parameters is different. In other words, the main structure for imaging is the same, but the auxiliary structure for imaging is different. Therefore, the imaging quality of the optical system of Embodiment 4 of the present application is shown in FIGS. 5A to 5D.

### Embodiment 5

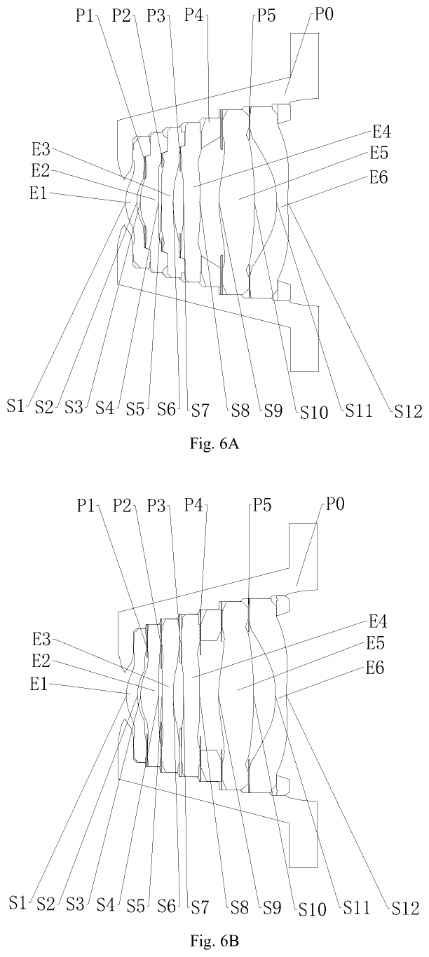

The optical system according to Embodiment 5 of the present application is described below with reference to FIG. 6A.

As shown in FIG. 6A, the optical system comprises a lens barrel P0, and a lens group and at least one spacer element accommodated in the lens barrel P0. The lens group comprises, in sequence from an object side to an image side, a first lens E1, a second lens E2, a third lens E3, a fourth lens E4, a fifth lens E5 and a sixth lens E6. The at least one spacer element comprises a first spacer element P1, a second spacer element P2, a third spacer element P3, a fourth spacer element P4 and a fifth spacer element P5.

The first lens E1 has positive refractive power, with a convex object-side surface S1 and a concave image-side surface S2. The second lens E2 has positive refractive power, with a convex object-side surface S3 and a concave image-side surface S4. The third lens E3 has negative refractive power, with a convex object-side surface S5 and a concave image-side surface S6. The fourth lens E4 has negative refractive power, with a convex object-side surface S7 and a concave image-side surface S8. The fifth lens E5 has positive refractive power, with a convex object-side surface S9 and a convex image-side surface S10. The sixth lens E6 has negative refractive power, with a concave object-side surface S11 and a concave image-side surface S12.

Table 5 shows a basic parameter table of the optical system of Embodiment 5, in which the units for the radius of curvature and thickness/distance are in millimeters (mm).

TABLE 5

| | | | | material | | |
|---|---|---|---|---|---|---|
| surface | surface | radius of | | refractive | Abbe | |
| number | type | curvature | thickness/distance | index | number | cone coefficient |
| OBJ | spherical | infinity | 400.0000 | | | |
| STO | spherical | infinity | 0.0300 | | | |
| S1 | aspherical | 1.0720 | 0.2500 | 1.543 | 65.1 | 0.0000 |
| S2 | aspherical | 1.0156 | 0.0744 | | | 0.0000 |
| S3 | aspherical | 1.2928 | 0.4089 | 1.544 | 56.0 | 0.0000 |
| S4 | aspherical | 23.8958 | 0.0737 | | | 0.0000 |
| S5 | aspherical | 20.3648 | 0.2523 | 1.646 | 21.5 | 0.0000 |
| S6 | aspherical | 2.5377 | 0.2347 | | | 0.0000 |
| S7 | aspherical | 45.6164 | 0.3616 | 1.636 | 23.7 | 0.0000 |
| S8 | aspherical | 8.4666 | 0.4298 | | | 0.0000 |
| S9 | aspherical | 2.3511 | 0.7930 | 1.564 | 41.9 | 0.0000 |
| S10 | aspherical | −22.4871 | 0.4944 | | | 0.0000 |
| S11 | aspherical | −3.0636 | 0.2500 | 1.550 | 44.2 | 0.0000 |
| S12 | aspherical | 4.8899 | 0.0600 | | | 0.0000 |
| S13 | spherical | infinity | 0.2100 | 1.518 | 64.2 | |
| S14 | spherical | infinity | 0.4600 | | | |
| S15 | spherical | infinity | | | | |

In Embodiment 5, the object-side surface and the image-side surface of any lens from the first lens E1 to the sixth lens E6 are both aspherical surfaces, and the surface shape of each aspherical lens can be defined by the formula (1) according to Embodiment 1 above. Tables 6-1 and 6-2 below give high-order coefficients A₄, A₆, A₈, A₁₀, A₁₂, A₁₄, A₁₆, A₁₈, A₂₀, A₂₂, A₂₄, A₂₆, A₂₈ and A₃₀ that can be used for each aspherical lens surface S1-S12 in Embodiment 5.

TABLE 6-1

| surface number | A4 | A6 | A8 | A10 | A12 | A14 | A16 |
|---|---|---|---|---|---|---|---|
| S1 | −3.3588E−03 | 5.1271E−05 | −1.5814E−05 | 2.3596E−06 | −1.3251E−06 | −1.9726E−06 | −2.3515E−06 |
| S2 | −9.7238E−03 | 2.0055E−04 | −5.8978E−05 | 8.9619E−06 | 5.1720E−06 | 3.7470E−06 | 2.2443E−07 |
| S3 | −5.8495E−03 | 4.7559E−04 | −2.4883E−05 | 9.4975E−06 | 9.6299E−06 | 5.7337E−06 | −6.9050E−09 |
| S4 | −2.6763E−03 | 1.4260E−03 | 1.0025E−04 | 7.5083E−06 | 2.7301E−05 | 3.3292E−05 | 4.3839E−06 |
| S5 | −1.3827E−02 | 1.0349E−03 | −1.2324E−06 | −7.2680E−06 | 3.3261E−05 | 4.2992E−05 | 3.6356E−06 |
| S6 | −8.3668E−03 | 1.9851E−03 | −1.5115E−04 | 7.7439E−05 | −1.2118E−05 | 2.2567E−05 | −1.4620E−05 |
| S7 | −7.6855E−02 | 2.3180E−03 | −2.1682E−03 | 1.4300E−04 | −1.3811E−04 | 2.0899E−05 | −1.3355E−05 |
| S8 | −1.6219E−01 | 3.1299E−02 | −6.2624E−03 | 1.2102E−03 | −6.3711E−04 | 1.6870E−04 | −1.1056E−04 |
| S9 | −9.4676E−01 | 1.5273E−01 | −3.8786E−02 | 7.4764E−03 | −3.6745E−03 | 2.4471E−03 | −1.8928E−03 |
| S10 | −3.5629E−01 | 2.5637E−02 | −3.8879E−03 | 1.6264E−02 | −9.6398E−03 | 4.8737E−03 | −1.4075E−03 |
| S11 | −4.5540E−01 | 1.0128E−01 | −8.1854E−02 | 4.2780E−02 | −2.2722E−02 | 1.5096E−03 | 2.5998E−03 |
| S12 | −1.4726E+00 | 2.6377E−01 | −5.6561E−02 | 2.9841E−02 | −1.5203E−02 | −5.1196E−04 | 2.2436E−03 |

TABLE 6-2

| surface number | A18 | A20 | A22 | A24 | A26 | A28 | A30 |
|---|---|---|---|---|---|---|---|
| S1 | −1.7992E−06 | −6.4809E−07 | 0.0000E+00 | 0.0000E+00 | 0.0000E+00 | 0.0000E+00 | 0.0000E+00 |
| S2 | −1.8817E−07 | 4.2000E−07 | 0.0000E+00 | 0.0000E+00 | 0.0000E+00 | 0.0000E+00 | 0.0000E+00 |
| S3 | −1.6486E−06 | −3.4413E−07 | 0.0000E+00 | 0.0000E+00 | 0.0000E+00 | 0.0000E+00 | 0.0000E+00 |
| S4 | −3.3571E−06 | −3.2241E−06 | 0.0000E+00 | 0.0000E+00 | 0.0000E+00 | 0.0000E+00 | 0.0000E+00 |
| S5 | −4.7994E−06 | −2.6868E−06 | 0.0000E+00 | 0.0000E+00 | 0.0000E+00 | 0.0000E+00 | 0.0000E+00 |
| S6 | −5.5123E−06 | −1.6145E−06 | 0.0000E+00 | 0.0000E+00 | 0.0000E+00 | 0.0000E+00 | 0.0000E+00 |
| S7 | −1.1021E−06 | 1.2214E−06 | 0.0000E+00 | 0.0000E+00 | 0.0000E+00 | 0.0000E+00 | 0.0000E+00 |
| S8 | 2.2940E−05 | 8.0008E−07 | 0.0000E+00 | 0.0000E+00 | 0.0000E+00 | 0.0000E+00 | 0.0000E+00 |
| S9 | 9.5908E−04 | −4.4346E−04 | 0.0000E+00 | 0.0000E+00 | 0.0000E+00 | 0.0000E+00 | 0.0000E+00 |
| S10 | −2.0155E−04 | 7.9208E−05 | 0.0000E+00 | 0.0000E+00 | 0.0000E+00 | 0.0000E+00 | 0.0000E+00 |
| S11 | −8.8018E−04 | −3.6781E−04 | 0.0000E+00 | 0.0000E+00 | 0.0000E+00 | 0.0000E+00 | 0.0000E+00 |
| S12 | 2.0344E−04 | −2.4035E−05 | 0.0000E+00 | 0.0000E+00 | 0.0000E+00 | 0.0000E+00 | 0.0000E+00 |

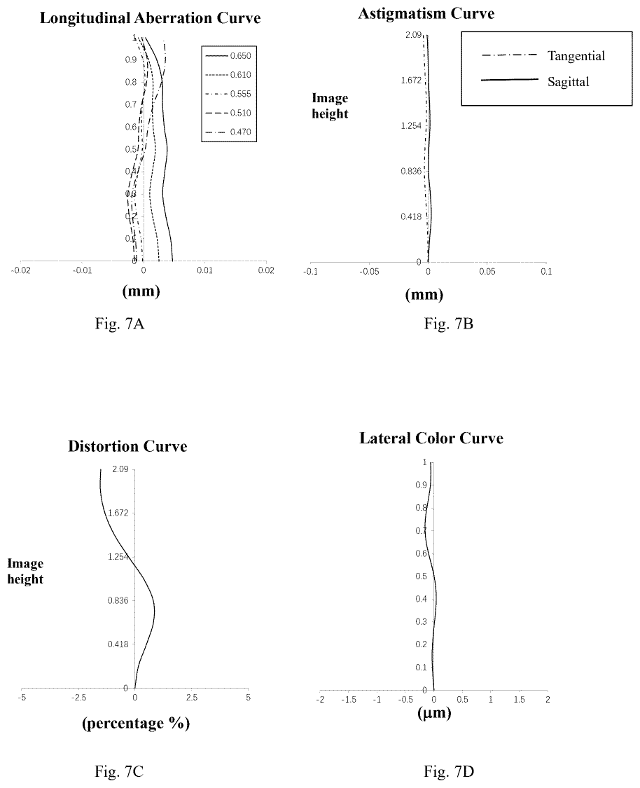

FIG. 7A shows a longitudinal aberration curve of the optical system of Embodiment 5, representing deviations of focal points of light of different wavelengths after passing through the lens assembly. FIG. 7B shows an astigmatism curve of the optical system of Embodiment 5, representing a curvature of a tangential plane and a curvature of a sagittal plane. FIG. 7C shows a distortion curve of the optical system of Embodiment 5, representing amounts of distortion corresponding to different image heights. FIG. 7D shows a lateral color curve of the optical system of Embodiment 5, representing deviation of different image heights on the imaging surface after light passes through the lens assembly. According to FIG. 7A to FIG. 7D, it can be seen that the optical system according to Embodiment 5 can achieve good imaging quality.

### Embodiment 6

The optical system according to Embodiment 6 of the present application is described below with reference to FIG. 6B.

As shown in FIG. 6B, the optical system comprises a lens barrel P0, and a lens group and at least one spacer element accommodated in the lens barrel P0. The lens group comprises, in sequence from an object side to an image side, a first lens E1, a second lens E2, a third lens E3, a fourth lens E4, a fifth lens E5 and a sixth lens E6. The at least one spacer element comprises a first spacer element P1, a second spacer element P2, a third spacer element P3, a fourth spacer element P4 and a fifth spacer element P5.

In this embodiment, the radii of curvature, center thicknesses, and other parameters of the first to sixth lenses of the optical system, as well as the spacing distances between the lenses and the higher-order coefficients, are the same as those in Embodiment 5, as shown in Table 5, Table 6-1 and Table 6-2. In addition, the number of spacer elements comprised in the optical system of this embodiment and Embodiment 5 is also the same, and the only difference lie in the actual parameters of the lens barrel and the respective spacer elements, such as the dimensions of the lens barrel, the thickness of the spacer elements, the inner and outer diameters of the spacer elements, and the spacing distances between the spacer elements, where at least one of these parameters is different. In other words, the main structure for imaging is the same, while the auxiliary structure for imaging is different. Therefore, the imaging quality of the optical system of Embodiment 6 of the present application is shown in FIGS. 7A to 7D.

### Embodiment 7

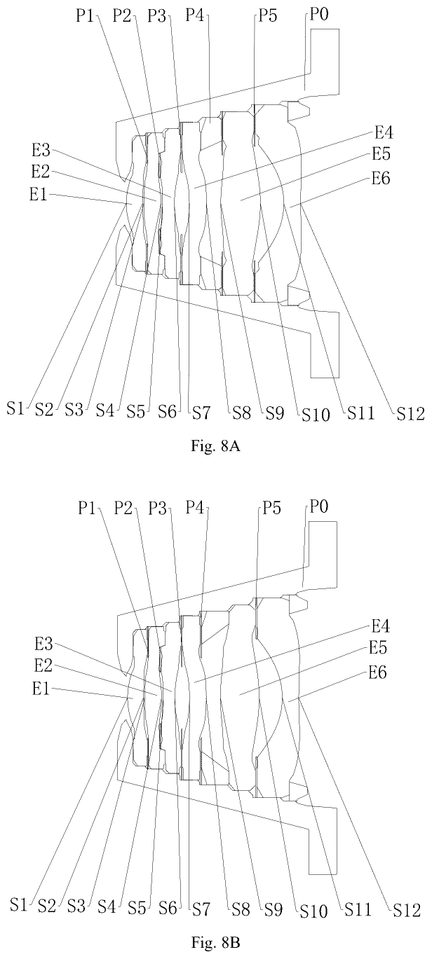

The optical system according to Embodiment 7 of the present application is described below with reference to FIG. 8A.

As shown in FIG. 8A, the optical system comprises a lens barrel P0, and a lens group and at least one spacer element accommodated in the lens barrel P0. The lens group comprises, in sequence from an object side to an image side, a first lens E1, a second lens E2, a third lens E3, a fourth lens E4, a fifth lens E5 and a sixth lens E6. The at least one spacer element comprises a first spacer element P1, a second spacer element P2, a third spacer element P3, a fourth spacer element P4 and a fifth spacer element P5.

The first lens E1 has positive refractive power, with a convex object-side surface S1 and a concave image-side surface S2. The second lens E2 has positive refractive power, with a convex object-side surface S3 and a convex image-side surface S4. The third lens E3 has negative refractive power, with a concave object-side surface S5 and a concave image-side surface S6. The fourth lens E4 has negative refractive power, with a concave object-side surface S7 and a convex image-side surface S8. The fifth lens E5 has positive refractive power, with a convex object-side surface S9 and a convex image-side surface S10. The sixth lens E6 has negative refractive power, with a concave object-side surface S11 and a concave image-side surface S12.

Table 7 shows a basic parameter table of the optical system of Embodiment 7, in which the units for the radius of curvature and thickness/distance are in millimeters (mm).

TABLE 7

| | | | | material | | |
|---|---|---|---|---|---|---|
| surface | surface | radius of | | refractive | Abbe | |
| number | type | curvature | thickness/distance | index | number | cone coefficient |
| OBJ | spherical | infinity | 400.0000 | | | |
| STO | spherical | infinity | 0.0300 | | | |
| S1 | aspherical | 1.4898 | 0.3600 | 1.514 | 60.3 | 0.0000 |
| S2 | aspherical | 3.1760 | 0.0300 | | | 0.0000 |
| S3 | aspherical | 4.4442 | 0.3790 | 1.544 | 56.0 | 0.0000 |
| S4 | aspherical | −2.5076 | 0.0377 | | | 0.0000 |
| S5 | aspherical | −8.3556 | 0.2620 | 1.592 | 29.2 | 0.0000 |
| S6 | aspherical | 2.2569 | 0.3315 | | | 0.0000 |
| S7 | aspherical | −3.8961 | 0.3785 | 1.578 | 32.7 | 0.0000 |
| S8 | aspherical | −10.7062 | 0.3197 | | | 0.0000 |
| S9 | aspherical | 3.1784 | 0.8795 | 1.546 | 49.0 | 0.0000 |
| S10 | aspherical | −3.4276 | 0.5211 | | | 0.0000 |
| S11 | aspherical | −1.6230 | 0.3714 | 1.535 | 55.8 | −1.0000 |
| S12 | aspherical | 7.5874 | 0.1943 | | | 0.0000 |
| S13 | spherical | infinity | 0.2100 | 1.518 | 64.2 | |
| S14 | spherical | infinity | 0.4900 | | | |
| S15 | spherical | infinity | | | | |

In Embodiment 7, the object-side surface and the image-side surface of any lens from the first lens E1 to the sixth lens E6 are both aspherical surfaces, and the surface shape of each aspherical lens can be defined by the formula (1) according to Embodiment 1 above. Tables 8-1 and 8-2 below give high-order coefficients A₄, A₆, A₈, A₁₀, A₁₂, A₁₄, A₁₆, A₁₈, A₂₀, A₂₂, A₂₄, A₂₆, A₂₈ and A₃₀ that can be used for each aspherical lens surface S1-S12 in Embodiment 7.

TABLE 8-1

| surface number | A4 | A6 | A8 | A10 | A12 | A14 | A16 |
|---|---|---|---|---|---|---|---|
| S1 | −1.0862E−02 | −1.0408E−03 | −8.3885E−05 | −1.2155E−05 | −5.5028E−06 | −3.7028E−06 | −1.3555E−06 |
| S2 | −2.3912E−02 | −3.8994E−04 | 3.3137E−04 | −3.6395E−05 | −1.5555E−05 | −2.4389E−06 | −6.8906E−07 |
| S3 | −5.3613E−03 | 1.4102E−03 | 4.7062E−04 | −6.1185E−05 | −2.1406E−05 | −2.5135E−06 | −1.4886E−07 |
| S4 | 7.0726E−03 | 1.1998E−03 | 1.6857E−04 | −5.7538E−05 | 1.3146E−05 | −3.2690E−06 | −1.2142E−06 |
| S5 | −1.9052E−02 | 3.0830E−05 | −2.0923E−05 | −8.0402E−05 | 1.8846E−05 | −4.4782E−06 | −1.4131E−06 |
| S6 | −2.7660E−02 | 4.0632E−03 | −2.2144E−04 | 1.0474E−04 | 3.6758E−05 | −2.2664E−05 | −1.5635E−06 |
| S7 | −5.5805E−02 | 9.0449E−03 | −2.2056E−03 | −8.6405E−04 | −1.2323E−04 | 1.9226E−04 | 8.0303E−05 |
| S8 | −2.1830E−01 | 4.2208E−02 | −5.2408E−03 | −1.1378E−03 | −7.0088E−04 | 5.1988E−04 | 1.2670E−04 |
| S9 | −8.0388E−01 | 1.6632E−01 | −3.6263E−02 | 1.0514E−02 | −4.3181E−03 | 1.7439E−03 | 5.7155E−05 |
| S10 | 4.5394E−01 | −8.0407E−02 | 1.4637E−02 | 1.1709E−02 | −2.1463E−03 | −1.6230E−04 | −9.8485E−04 |
| S11 | 1.4304E−01 | 5.7681E−02 | −3.0828E−02 | 2.0231E−03 | −5.9880E−03 | −2.2057E−03 | 4.6156E−04 |
| S12 | −1.0257E+00 | 1.5054E−01 | −1.1217E−02 | 1.0016E−03 | −7.9872E−03 | −3.4302E−03 | −4.6790E−04 |

TABLE 8-2

| surface number | A18 | A20 | A22 | A24 | A26 | A28 | A30 |
|---|---|---|---|---|---|---|---|
| S1 | −1.6656E−07 | 3.5711E−07 | 0.0000E+00 | 0.0000E+00 | 0.0000E+00 | 0.0000E+00 | 0.0000E+00 |
| S2 | 4.5219E−07 | 3.3098E−07 | 0.0000E+00 | 0.0000E+00 | 0.0000E+00 | 0.0000E+00 | 0.0000E+00 |
| S3 | 7.3246E−07 | 3.3940E−07 | 0.0000E+00 | 0.0000E+00 | 0.0000E+00 | 0.0000E+00 | 0.0000E+00 |
| S4 | −6.2749E−07 | 4.5644E−07 | 0.0000E+00 | 0.0000E+00 | 0.0000E+00 | 0.0000E+00 | 0.0000E+00 |
| S5 | −2.6704E−07 | 6.7838E−07 | 0.0000E+00 | 0.0000E+00 | 0.0000E+00 | 0.0000E+00 | 0.0000E+00 |
| S6 | 1.4639E−06 | −1.2402E−06 | 0.0000E+00 | 0.0000E+00 | 0.0000E+00 | 0.0000E+00 | 0.0000E+00 |
| S7 | 2.8941E−05 | 1.0795E−05 | 0.0000E+00 | 0.0000E+00 | 0.0000E+00 | 0.0000E+00 | 0.0000E+00 |
| S8 | 4.9513E−05 | 1.4247E−05 | 0.0000E+00 | 0.0000E+00 | 0.0000E+00 | 0.0000E+00 | 0.0000E+00 |
| S9 | 6.1316E−04 | −9.2035E−04 | 0.0000E+00 | 0.0000E+00 | 0.0000E+00 | 0.0000E+00 | 0.0000E+00 |
| S10 | 3.0387E−04 | 1.1368E−05 | 0.0000E+00 | 0.0000E+00 | 0.0000E+00 | 0.0000E+00 | 0.0000E+00 |
| S11 | 1.9724E−04 | −2.3881E−04 | 0.0000E+00 | 0.0000E+00 | 0.0000E+00 | 0.0000E+00 | 0.0000E+00 |
| S12 | 1.5197E−04 | 3.4539E−04 | 0.0000E+00 | 0.0000E+00 | 0.0000E+00 | 0.0000E+00 | 0.0000E+00 |

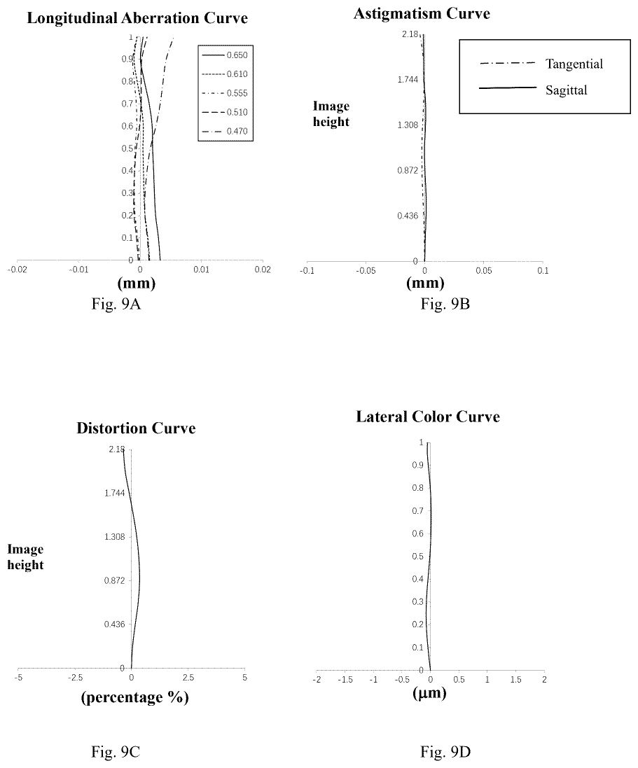

FIG. 9A shows a longitudinal aberration curve of the optical system of Embodiment 7, representing deviations of focal points of light of different wavelengths after passing through the lens assembly. FIG. 9B shows an astigmatism curve of the optical system of Embodiment 7, representing a curvature of a tangential plane and a curvature of a sagittal plane. FIG. 9C shows a distortion curve of the optical system of Embodiment 7, representing amounts of distortion corresponding to different image heights. FIG. 9D shows a lateral color curve of the optical system of Embodiment 7, representing deviation of different image heights on the imaging surface after light passes through the lens assembly. According to FIG. 9A to FIG. 9D, it can be seen that the optical system according to Embodiment 7 can achieve good imaging quality.

### Embodiment 8

The optical system according to Embodiment 8 of the present application is described below with reference to FIG. 8B.

As shown in FIG. 8B, the optical system comprises a lens barrel P0, and a lens group and at least one spacer element accommodated in the lens barrel P0. The lens group comprises, in sequence from an object side to an image side, a first lens E1, a second lens E2, a third lens E3, a fourth lens E4, a fifth lens E5 and a sixth lens E6. The at least the spacer element comprises a first spacer element P1, a second spacer element P2, a third spacer element P3, a fourth spacer element P4 and a fifth spacer element P5.

In this embodiment, the radii of curvature, center thicknesses, and other parameters of the first to sixth lenses of the optical system, as well as the spacing distances between the lenses and the higher-order coefficients, are the same as those in Embodiment 7, as shown in Table 7, Table 8-1 and Table 8-2. In addition, the number of spacer elements comprised in the optical system of this embodiment and Embodiment 7 is also the same, and the only difference lie in the actual parameters of the lens barrel and the respective spacer elements, such as the dimensions of the lens barrel, the thickness of the spacer elements, the inner and outer diameters of the spacer elements, and the spacing distances between the spacer elements, where at least one of these parameters is different. In other words, the main structure for imaging is the same, while the auxiliary structure for imaging is different. Therefore, the imaging quality of the optical system of Embodiment 8 of the present application is shown in FIGS. 9A to 9D.

Table 9 below shows the effective focal length values of each lens in the optical system of Embodiments 1 to 8, and the unit for the effective focal length value is in millimeter (mm).

TABLE 9

| | embodiment | | | | | | | |
|---|---|---|---|---|---|---|---|---|
| parameter value | 1 | 2 | 3 | 4 | 5 | 6 | 7 | 8 |
| f1 | 4.67 | 4.67 | 4.09 | 4.09 | 62.91 | 62.91 | 5.07 | 5.07 |
| f2 | 2.88 | 2.88 | 2.71 | 2.71 | 2.49 | 2.49 | 2.99 | 2.99 |
| f3 | −2.38 | −2.38 | −1.83 | −1.83 | −4.47 | −4.47 | −2.95 | −2.95 |
| f4 | −5.00 | −5.00 | −3.61 | −3.61 | −16.26 | −16.26 | −10.75 | −10.75 |
| f5 | 2.35 | 2.35 | 1.69 | 1.69 | 3.80 | 3.80 | 3.15 | 3.15 |
| f6 | −2.77 | −2.77 | −2.55 | −2.55 | −3.37 | −3.37 | −2.46 | −2.46 |

Table 10 below shows some basic parameters of the lens barrel and the spacer elements of the optical system of Embodiments 1 to 8, such as d1m, D1s, d2m, d3s, d4s, D34m, d5m, d0m, CP2, CP3, CP4, CP5, EP01, EP12, EP23, EP34, EP45, etc. The units for the basic parameters listed in Table 10 are in millimeters (mm).

TABLE 10

| parameter | embodiment | | | | | | | |
|---|---|---|---|---|---|---|---|---|
| value | 1 | 2 | 3 | 4 | 5 | 6 | 7 | 8 |
| d1m | 1.192 | 1.192 | 1.097 | 1.106 | 1.108 | 1.720 | 1.795 | 1.795 |
| D1s | 2.187 | 3.375 | 2.092 | 3.247 | 2.060 | 3.179 | 3.186 | 3.186 |
| d2m | 1.703 | 1.224 | 1.183 | 1.183 | 1.581 | 1.209 | 1.141 | 1.141 |
| d3s | 1.468 | 1.516 | 1.627 | 1.627 | 1.449 | 1.492 | 1.423 | 1.423 |
| d4s | 2.584 | 2.584 | 2.561 | 2.971 | 2.442 | 1.861 | 2.395 | 1.809 |
| D4m | 3.959 | 4.073 | 4.375 | 4.161 | 3.834 | 3.834 | 3.770 | 3.885 |
| d5m | 2.702 | 2.702 | 4.103 | 3.450 | 2.822 | 2.822 | 2.567 | 2.610 |
| d0m | 5.043 | 5.039 | 5.157 | 5.157 | 4.727 | 4.727 | 4.929 | 4.929 |
| CP2 | 0.022 | 0.022 | 0.022 | 0.022 | 0.022 | 0.022 | 0.022 | 0.022 |
| CP3 | 0.022 | 0.063 | 0.053 | 0.053 | 0.022 | 0.034 | 0.022 | 0.022 |
| CP4 | 0.467 | 0.467 | 0.022 | 0.435 | 0.435 | 0.022 | 0.467 | 0.022 |
| CP5 | 0.022 | 0.022 | 0.275 | 0.275 | 0.022 | 0.022 | 0.022 | 0.030 |
| EP01 | 0.700 | 0.697 | 0.655 | 0.677 | 0.612 | 0.648 | 0.676 | 0.676 |
| EP12 | 0.385 | 0.353 | 0.347 | 0.325 | 0.362 | 0.299 | 0.257 | 0.257 |
| EP23 | 0.507 | 0.541 | 0.593 | 0.593 | 0.372 | 0.406 | 0.464 | 0.464 |
| EP34 | 0.686 | 0.645 | 0.542 | 0.542 | 0.470 | 0.425 | 0.417 | 0.417 |
| EP45 | 0.504 | 0.504 | 0.957 | 0.544 | 0.635 | 1.073 | 0.717 | 1.220 |

TABLE 11

| | Embodiment | | | | | | | |
|---|---|---|---|---|---|---|---|---|
| conditional formula | 1 | 2 | 3 | 4 | 5 | 6 | 7 | 8 |
| d0m/R12 | 2.10 | 2.10 | 4.91 | 4.91 | 0.97 | 0.97 | 0.65 | 0.65 |
| (CT2 + CP2)/CT3 | 1.37 | 1.37 | 1.36 | 1.36 | 1.71 | 1.71 | 1.53 | 1.53 |
| f2/(EP12 + EP23) | 3.23 | 3.22 | 2.88 | 2.95 | 3.39 | 3.53 | 4.15 | 4.15 |
| (EP01 + CT1)/T12 | 33.73 | 33.65 | 12.70 | 12.97 | 11.59 | 12.08 | 34.52 | 34.52 |
| f3/(T34 + CP3) | −5.03 | −4.62 | −2.38 | −2.38 | −17.42 | −16.67 | −8.35 | −8.35 |
| (CT4 + T45)/EP34 | 1.30 | 1.38 | 0.85 | 0.85 | 1.69 | 1.86 | 1.67 | 1.67 |
| (CP4 + EP45)/CT5 | 1.53 | 1.53 | 0.99 | 0.99 | 1.35 | 1.38 | 1.35 | 1.41 |
| R1/D1s | 0.71 | 0.46 | 0.77 | 0.49 | 0.52 | 0.34 | 0.47 | 0.47 |
| R3/d1m | 3.00 | 3.00 | 2.94 | 2.91 | 1.17 | 0.75 | 2.48 | 2.48 |
| (R4 − R5)/d2m | 3.36 | 4.68 | 2.63 | 2.63 | 2.23 | 2.92 | 5.13 | 5.13 |
| V3 | 30.00 | 30.00 | 33.60 | 33.60 | 21.50 | 21.50 | 29.20 | 29.20 |
| R6/d3s | 1.17 | 1.13 | 0.83 | 0.83 | 1.75 | 1.70 | 1.59 | 1.59 |
| V4 | 33.00 | 33.00 | 42.20 | 42.20 | 23.70 | 23.70 | 32.70 | 32.70 |
| \|R8/d4s\| | 6.52 | 6.52 | 1.63 | 1.41 | 3.47 | 4.55 | 4.47 | 5.92 |
| R9/D4m | 0.60 | 0.59 | 0.43 | 0.45 | 0.61 | 0.61 | 0.84 | 0.82 |
| f6/(CT6 + T56 + CP5) | −3.40 | −3.40 | −2.74 | −2.74 | −4.40 | −4.40 | −2.69 | −2.66 |
| \|R11/d5m\| | 1.95 | 1.95 | 1.16 | 1.38 | 1.09 | 1.09 | 0.63 | 0.62 |

Table 12-1 below shows the structural sensitivity of the space gap between the second lens and the third lens in the three samples of the optical system. Specifically, Table 12-1 shows the changes in the center and edge of the second lens and the third lens relative to the design value (i.e., the center point displacement and the edge point displacement) when the same load is applied to the three samples of the optical system, and the structural sensitivity ΔSP2 of the air interval between the second lens and the third lens on the optical axis (i.e., the center area gap change value of the second lens and the third lens). The units for the center point displacement, edge point displacement and ΔSp2 in Table 12-1 are all in micrometers (μm).

More specifically, when the same load is applied to the structural area (i.e., the non-effective diameter portion) of Sample 1, Sample 2 and Sample 3 of the optical system, the force acting on the structural area is transmitted from the edge position to the center position, resulting in a deformation. For example, when the structural areas of the image-side surfaces of the third lenses in Sample 1, Sample 2, and Sample 3 are subjected to the same external force, under the influence of stress, both the edge and center positions of the second lens and the third lens undergo deformation. This, in turn, causes a change in the air interval between the second lens and the third lens. For example, referring to Table 12-1, through simulation, the structural sensitivity ΔSP2 of Sample 1, Sample 2 and Sample 3 of the optical system are 0.277 μm, 0.918 μm and 2.3032 μm, respectively. It can be seen that the displacement of Sample 1 of the optical system is relatively small and the structural sensitivity is better.

TABLE 12-1
analysis of the structural sensitivity of the gap between the second lens and the third lens

| | | Sample 1 | | Sample 2 | | Sample 3 | |
|---|---|---|---|---|---|---|---|
| | | (CT2 + CP2)/CT3 = 1.5 | | (CT2 + CP2)/CT3 = 1.3 | | (CT2 + CP2)/CT3 = 1.77 | |
| | | f2/(EP12 + EP23) = 3.55 | | f2/(EP12 + EP23) = 2.8 | | f2/(EP12 + EP23) = 4.16 | |
| optical system | | center point | edge point | center point | edge point | center point | edge point |
| solutions | | displacement | displacement | displacement | displacement | displacement | displacement |
| second | object- | 3.92E−05 | 2.68E−05 | 2.11E−04 | 1.51E−04 | 2.72E−04 | 7.60E−04 |
| lens | side | | | | | | |
| | surface | | | | | | |
| | image- | −3.50E−05 | −2.29E−05 | −2.10E−04 | −1.33E−04 | −6.85E−04 | −4.34E−04 |
| | side | | | | | | |
| | surface | | | | | | |
| third | object- | −3.12E−04 | 1.28E−04 | −1.13E−03 | 3.67E−04 | −2.99E−03 | 7.16E−04 |
| lens | side | | | | | | |
| | surface | | | | | | |
| | image- | 3.50E−03 | −3.71E−04 | 4.80E−03 | −4.65E−04 | 6.05E−03 | −5.64E−04 |
| | side | | | | | | |
| | surface | | | | | | |

| structural | 0.277 | 0.918 | 2.3032 |
|---|---|---|---|
| sensitivity ΔSP2 | | | |

The following Table 12-2 shows the optical sensitivity and comprehensive sensitivity of the space gap between the second lens and the third lens in the above three samples of the optical system. Specifically, Table 12-2 shows the change in the MTF (Modulation Transfer Function) peak value of the marginal field of view (1.0F) when the space interval between the second lens and the third lens on the optical axis of the three samples of the optical system changes by +1 μm and −1 μm. That is, the optical sensitivity can represent the change in the MTF peak value of the marginal field of view of the optical system under a fixed displacement of the lens assembly (i.e., a drop condition). In Table 12-2, the symbols “+” and “−” in +1 μm and −1 μm indicate the fluctuation direction of the space interval between two adjacent lenses compared to the design value. The MTF peak value is in percentage (%).

Referring to Table 12-2, through simulation, when the space interval between the second lens and the third lens on the optical axis changes by +1 μm, the change in the MTF peak value of the marginal field of view of Sample 1, Sample 2 and Sample 3 of the optical system is −0.3%, −0.9%, −1.1%, respectively; when the space interval between the second lens and the third lens on the optical axis changes by −1 μm, the change in the MTF peak value of the marginal field of view of Sample 1, Sample 2 and Sample 3 of the optical system is 0%, −0.5%, −0.2%, respectively. According to the comparison results, it can be seen that the MTF peak value of Sample 1 of the optical system is less affected by force deformation and has better optical sensitivity.

TABLE 12-2
analysis of optical sensitivity of the gap between the second lens and the third lens

| | Sample 1 | | Sample 2 | | Sample 3 | |
|---|---|---|---|---|---|---|
| optical system | (CT2 + CP2)/CT3 = 1.5 | | (CT2 + CP2)/CT3 = 1.3 | | (CT2 + CP2)/CT3 = 1.77 | |
| solutions | f2/(EP12 + EP23) = 3.55 | | f2/(EP12 + EP23) = 2.8 | | f2/(EP12 + EP23) = 4.16 | |
| air interval | +1 μm | −1 μm | +1 μm | −1 μm | +1 μm | −1 μm |
| change | | | | | | |
| MTF peak value | −0.3 | 0 | −0.9 | −0.5 | −1.1 | −0.2 |
| change (%) | | | | | | |
| comprehensive | −0.0831 | | −0.8263 | | −2.53352 | |
| sensitivity (μm) | | | | | | |
| conclusion/ | good | | poor | | poor | |
| stability | | | | | | |

Furthermore, it can be concluded that the comprehensive sensitivities of the three samples of the optical system are −0.0831 μm, −0.8263 μm, and −2.53352 μm, respectively. The comprehensive sensitivity refers to how much deformation will affect the MTF peak value. According to the comparison results, it can be seen that Sample 1 of the optical system is less deformed by force, and the deformation has a weaker effect on MTF. The comprehensive sensitivity is significantly better than that of Sample 2 and Sample 3, and the stability is better.

Through the above experimental comparison of different samples of the optical system, it can be found that when the optical system meets the numerical range of the conditional formula 1.36≤(CT2+CP2)/CT3≤1.71 and 2.88≤f2/(EP12+EP23)≤4.15, the center point displacement and edge point displacement of the second lens and the third lens are smaller, the MTF peak value is less affected by the change of the air interval between the lenses, and the assembly stability is higher. Therefore, by appropriately controlling the numerical range of the above parameter conditional formulas, the optical system can meet the conditional formulas 1.36≤(CT2+CP2)/CT3≤1.71 and 2.88≤f2/(EP12+EP23)≤4.15 at the same time, which can make the comprehensive sensitivity of the optical system better and more stable.

The above description is merely a preferred embodiment of this application and an explanation of the technical principles applied. Those skilled in the art should understand that the scope of the invention involved in this application is not limited to the technical solution formed by a specific combination of the above technical features, but should also cover other technical solutions formed by any combination of the above technical features or their equivalent features without departing from the inventive concept. For example, technical solutions may be formed by replacing the aforementioned features with technical features disclosed in this application (but not limited to) that have similar functions.

What is claimed is:

1. An optical system, comprising a lens barrel with an accommodating space, and a lens group and at least one spacer element accommodated in the lens barrel,
wherein the lens group comprises a first lens with positive refractive power, a second lens with positive refractive power, a third lens with negative refractive power, a fourth lens with negative refractive power, a fifth lens with positive refractive power, and a sixth lens with negative refractive power, which are arranged in sequence from an object side to an image side along an optical axis;
the at least one spacer element comprises a first spacer element located between the first lens and the second lens and in direct contact with an image-side surface of the first lens, a second spacer element located between the second lens and the third lens and in direct contact with an image-side surface of the second lens, and a third spacer element located between the third lens and the fourth lens and in direct contact with an image-side surface of the third lens,
wherein the number of lenses with refractive power in the lens group is six;
a center thickness CT2 of the second lens on the optical axis, a center thickness CT3 of the third lens on the optical axis, and a maximum thickness CP2 of the second spacer element satisfy: 1.36≤(CT2+CP2)/CT3≤1.71;
an effective focal length f2 of the second lens, an interval EP12 between the first spacer element and the second spacer element, and an interval EP23 between the second spacer element and the third spacer element satisfy: 2.88≤f2/(EP12+EP23)≤4.15.

2. The optical system according to claim 1, wherein an inner diameter d0m of a rear end surface of the lens barrel closest to an imaging surface and a radius of curvature R12 of an image-side surface of the sixth lens satisfy: 0.65≤d0m/R12≤4.91.

3. The optical system according to claim 1, wherein an interval EP01 between a front end surface of the lens barrel and the first spacer element, a center thickness CT1 of the first lens on the optical axis, and an air interval T12 between the first lens and the second lens on the optical axis satisfy: 11.59≤(EP01+CT1)/T12≤34.52.

4. The optical system according to claim 1, wherein an air interval T34 between the third lens and the fourth lens on the optical axis, an effective focal length f3 of the third lens, and a maximum thickness CP3 of the third spacer element satisfy: −17.42≤f3/(T34+CP3)≤−2.38.

5. The optical system according to claim 1, wherein the at least one spacer element further comprises a fourth spacer element located between the fourth lens and the fifth lens and in direct contact with an image-side surface of the fourth lens,
a center thickness CT4 of the fourth lens on the optical axis, an air interval T45 between the fourth lens and the fifth lens on the optical axis, and an interval EP34 between the third spacer element and the fourth spacer element satisfy: 0.85≤(CT4+T45)/EP34≤1.86.

6. The optical system according to claim 1, wherein the at least one spacer element further comprises a fourth spacer element located between the fourth lens and the fifth lens and in direct contact with an image-side surface of the fourth lens, and a fifth spacer element located between the fifth lens and the sixth lens and in direct contact with an image-side surface of the fifth lens,
a maximum thickness CP4 of the fourth spacer element, an interval EP45 between the fourth spacer element and the fifth spacer element, and a center thickness CT5 of the fifth lens on the optical axis satisfy: 0.99≤(CP4+EP45)/CT5≤1.53.

7. The optical system according to claim 1, wherein a radius of curvature R1 of an object-side surface of the first lens and an outer diameter Dis of an object-side surface of the first spacer element satisfy: 0.34≤R1/D1s≤0.77.

8. The optical system according to claim 1, wherein a radius of curvature R3 of an object-side surface of the second lens and an inner diameter dim of an image-side surface of the first spacer element satisfy: 0.75≤R3/d1m≤3.00.

9. The optical system according to claim 1, wherein a radius of curvature R4 of the image-side surface of the second lens, a radius of curvature R5 of an object-side surface of the third lens, and an inner diameter d2m of an image-side surface of the second spacer element satisfy: 2.23≤(R4−R5)/d2m≤5.13.

10. The optical system according to claim 1, wherein an Abbe number V3 of the third lens satisfies: 21.5≤V3≤34; a radius of curvature R6 of the image-side surface of the third lens and an inner diameter d3s of an object-side surface of the third spacer element satisfy: 0.83≤R6/d3s≤1.75.

11. The optical system according to claim 1, wherein the at least one spacer element further comprises a fourth spacer element located between the fourth lens and the fifth lens and in direct contact with an image-side surface of the fourth lens,
an Abbe number V4 of the fourth lens satisfies: 23.7≤V4≤42.2; a radius of curvature R8 of the image-side surface of the fourth lens and an inner diameter d4s of an object-side surface of the fourth spacer element satisfy: 1.41≤|R8/d4s|≤6.52.

12. The optical system according to claim 1, wherein the at least one spacer element further comprises a fourth spacer element located between the fourth lens and the fifth lens and in direct contact with an image-side surface of the fourth lens,
a radius of curvature R9 of an object-side surface of the fifth lens and an outer diameter D4m of an image-side surface of the fourth spacer element satisfy: 0.43≤R9/D4m≤0.84.

13. The optical system according to claim 1, wherein the at least one spacer element further comprises a fifth spacer element located between the fifth lens and the sixth lens and in direct contact with an image-side surface of the fifth lens,
an effective focal length f6 of the sixth lens, a center thickness CT6 of the sixth lens on the optical axis, an air interval T56 between the fifth lens and the sixth lens on the optical axis, and a maximum thickness CP5 of the fifth spacer element satisfy: −4.4≤f6/(CT6+T56+CP5)≤−2.66.

14. The optical system according to claim 1, wherein the at least one spacer element further comprises a fifth spacer element located between the fifth lens and the sixth lens and in direct contact with an image-side surface of the fifth lens, and
a radius of curvature R11 of an object-side surface of the sixth lens and an inner diameter d5m of an image-side surface of the fifth spacer element satisfy: 0.62≤|R11/d5m|≤1.95.

15. The optical system of claim 1, wherein
an object-side surface of the first lens is a convex surface, and the image-side surface of the first lens is a concave surface;
an object-side surface of the second lens is a convex surface;
the image-side surface of the third lens is a concave surface;
an object-side surface of the fifth lens is a convex surface, and an image-side surface of the fifth lens is a convex surface;
an image-side surface of the sixth lens is a concave surface.
